(19) United States
(12) Patent Application Publication
(10) Pub. No.: US 2013/0154876 A1
(43) Pub. Date: Jun. 20, 2013

(54) TARGET VELOCITY IDENTIFICATION APPARATUS, TARGET VELOCITY IDENTIFICATION PROGRAM, AND TARGET VELOCITY IDENTIFICATION METHOD

(71) Applicant: Motofumi Arii, Kamakura-shi (JP)

(72) Inventor: Motofumi Arii, Kamakura-shi (JP)

(73) Assignee: MITSUBISHI SPACE SOFTWARE CO., LTD., Tokyo (JP)

(21) Appl. No.: 13/819,662

(22) PCT Filed: Sep. 15, 2011
(86) PCT No.: PCT/JP2011/071067

§ 371 Date: Feb. 27, 2013

(30) Foreign Application Priority Data
Sep. 15, 2010 (JP) 2010-206305

(51) Int. Cl. G01S 13/58

(52) U.S. Cl. CPC G01S 13/58
USPC 342/25 R

(57) ABSTRACT

An object of the present invention is to identify the velocity of a target with high precision and with a small amount of computation. A step size determination unit 3 inputs a velocity v_{P} of a SAR platform, a distance R₀, an wavelength λ of an electric wave, and a synthetic aperture time τ being observation conditions of SAR image data to a function of an amplitude value V₀^{vaz} expressed by the velocity v_{P} of the SAR platform, the distance R₀, the wavelength λ of the electric wave, the synthetic aperture time τ, and a predicted velocity vₐ′ of the target in an azimuth direction to compute the amplitude value V₀^{vaz} corresponding to the predicted velocity vₐ′. The step size determination unit 3 identifies a range of the predicted velocity vₐ′ in the azimuth direction where the amplitude value V₀^{vaz} becomes a predetermined value or higher, using a processing device, and then sets a velocity width equal to or smaller than a velocity width of the identified range to a step size Δvₐ₁. An identification process execution unit identifies the velocity of the target in the azimuth direction by the processing device, using the step size Δvₐ₁.

### TECHNICAL FIELD

The present invention relates to a technique for identifying the velocity of a target from a SAR (Synthetic Aperture Radar) image, for example.

### BACKGROUND ART

Patent Literature 1 describes a refocus ISAR (Inverse SAR) that identifies the velocity of a target using a SAR image after azimuth compression (azimuth-compressed data).

In the refocus ISAR, the azimuth-compressed data is decompressed, using a reference function employed for the azimuth compression, thereby generating data before the azimuth compression. Then, a plurality of reference functions is produced by varying the predicted target velocity. The data before the azimuth compression is then azimuth compressed again, using each of the produced reference functions, thereby generating a plurality of azimuth-compressed data. The reference function used when most vivid image data (having a largest amplitude value) among the generated plurality of azimuth-compressed images is obtained is identified. Then, the predicted target velocity t used when the identified reference function is produced is identified to be the target velocity.

### CITATION LIST

### Patent Literature

Patent Literature 1: JP 2007-292532 A

### Non Patent Literature

Non Patent Literature 1: C. Elachi and J. van Zyl, Introduction to the physics and techniques of remote sensing, Hoboken, N.J.: John Wiley & Sons, 2006.

### SUMMARY OF INVENTION

### Technical Problem

In the refocus ISAR, a variation size of the predicted target velocity must be reduced to perform computation based on a lot of predicted velocities, in order to identify the target velocity with high precision. For that reason, when the target velocity is to be identified with the high precision, the amount of computation will increase.

An object of the present invention is therefore to identify the velocity of a target with high precision and with a small amount of computation.

### Solution to Problem

A target velocity identification apparatus according to the present invention is a target velocity identification apparatus which identifies a velocity of a target observed by a SAR (Synthetic Aperture Radar) including:

a data input unit which inputs data on the target observed by the SAR under observation conditions of a velocity v_{P} of a SAR platform with the SAR mounted thereon, a distance R₀ between the SAR and the target at a center of a synthetic aperture, a wavelength λ of an electric wave emitted from the SAR, and a synthetic aperture time τ;

a step size determination unit which inputs the velocity V_{P} of the SAR platform, the distance R₀, the wavelength λ of the electric wave, and the synthetic aperture time τ being the observation conditions of the data input by the data input unit to a function of an amplitude value V₀^{vaz} expressed by the velocity v_{P} of the SAR platform, the distance R₀, the wavelength λ of the electric wave, the synthetic aperture time τ, and a predicted velocity vₐ′ of the target in an azimuth direction to compute the amplitude value V₀^{vaz} corresponding to the predicted velocity vₐ═, identifies a range of the predicted velocity vₐ′ in the azimuth direction where the amplitude value V₀^{vaz} becomes a predetermined value or larger by a processing device, and then sets a velocity width equal to or smaller than a velocity width of the identified range to a step size Δvₐ₁; and

an identification process execution unit which identifies the velocity of the target in the azimuth direction using the step size Δvₐ₁ determined by the step size determination unit.

The step size determination unit inputs the velocity v_{P} of the SAR platform, the distance R₀, the wavelength λ of the electric wave, and the synthetic aperture time τ being the observation conditions of the data input by the data input unit and a certain value as a velocity vₐ of the target to the function of the amplitude value V₀^{vaz} expressed by Equation 1, thereby computing the amplitude value V₀^{vaz} corresponding to the predicted velocity V ₐ′:

$$\vert {V}_{0}^{vaz} ( {v}_{a} , {v}_{a}^{′} ) \vert = - \vert α \vert \sqrt{\frac{λ {R}_{0}}{\vert ( {v}_{a} - {v}_{a}^{′} ) ( {v}_{a} + {v}_{a}^{′} - 2 {v}_{P} ) \vert}} \cdot \vert {\int }_{0}^{τ \sqrt{\vert ( {v}_{a} - {v}_{a}^{′} ) ( {v}_{a} + {v}_{a}^{′} - 2 {v}_{P} ) \vert / λ {R}_{0}}} exp ( ∓ j {p}^{2} ) d p \vert \qquad [ Equation 1 ]$$

where α is an arbitrary constant, j is an imaginary unit, and a lowercase p is an integral operator.

Based on the function expressed by Equation 1, the step size determination unit sets a value larger than the amplitude value V₀^{vaz} at a top of a peak which is a second largest amplitude value in a graph to the predetermined value, the graph being obtained by plotting values of the amplitude value V₀^{vaz} for respective predicted velocities in the azimuth direction.

The data input unit inputs range-compressed data obtained by range compression, as the data on the target; and

the identification process execution unit includes:

a predicted velocity input unit which inputs a predicted velocity of the target in a range direction, and also inputs the predicted velocities of the target in the azimuth direction for each step size Δvₐ₁ determined by the step size determination unit;

a reference function production unit which produces a reference function obtained from a relative distance between the SAR and the target, for each of the predicted velocities in the azimuth direction, using the processing device, based on the predicted velocity in the range direction and the predicted velocities in the azimuth direction input by the predicted velocity input unit, thereby producing a plurality of reference functions;

an azimuth compression process unit which azimuth compresses the range-compressed data input by the data input unit, based on each reference function of the plurality of reference functions produced by the reference function production unit, thereby generating a plurality of azimuth-compressed data, using the processing device;

an amplitude value computation unit which computes an amplitude value of an image of the target in each azimuth-compressed data of the plurality of azimuth-compressed data generated by the azimuth compression process unit, using the processing device; and

a velocity identification unit which, using the processing device, identifies that the velocity of the target in the azimuth direction falls within a range plus and minus a step size Δ vₐ₁/2 from one of the predicted velocities in the azimuth direction, the one of the predicted velocities in the azimuth direction being the predicted velocity used when the reference function production unit has produced the reference function used for generating the azimuth-compressed data having a maximum amplitude value of the image of the target computed by the amplitude value computation unit.

The predicted velocity input unit newly inputs the predicted velocities in the azimuth direction in the velocity range plus and minus the step size Δ vₐ₁/2 from the velocity identified by the velocity identification unit, for each step size Δvₐ₂ narrower than the step size Δvₐ₁;

based on the predicted velocity in the range direction and the predicted velocities in the azimuth direction newly input by the predicted velocity input unit, the reference function production unit produces a reference function obtained from the relative distance, for each of the predicted velocities in the azimuth direction, thereby newly producing a plurality of reference functions;

the azimuth compression process unit azimuth compresses the range-compressed data, based on each function of the plurality of reference functions newly produced by the reference function production unit, thereby newly generating a plurality of azimuth-compressed data;

the amplitude value computation unit newly computes an amplitude value of an image of the target in each azimuth-compressed data of the plurality of azimuth-compressed data newly generated by the azimuth compression process unit; and

the velocity identification unit identifies, as the velocity of the target in the azimuth direction, one of the predicted velocities in the azimuth direction, the one of the predicted velocities being the predicted velocity used when the reference function production unit has produced the reference function used for generating the azimuth-compressed data having a maximum amplitude value of the image of the target newly computed by the amplitude value computation unit.

The predicted velocity input unit newly inputs each of at least one velocity slower than a velocity vᵣ of the target in the range direction and at least one velocity faster than the velocity vᵣ of the target in the range direction, as the predicted velocity in the range direction;

based on the predicted velocities in the range direction newly input by the predicted velocity input unit and the velocity of the target in the azimuth direction identified by the velocity identification unit, the reference function production unit produces a reference function obtained from the relative distance, for each of the predicted velocities in the range direction, thereby newly producing a plurality of reference functions;

the azimuth compression process unit azimuth compresses the range-compressed data, based on each reference function of the plurality of reference functions newly produced by the reference function production unit, thereby newly generating a plurality of azimuth-compressed data;

the amplitude value computation unit computes an amplitude value of an image of the target in each azimuth-compressed data of the plurality of azimuth-compressed data newly generated by the azimuth compression process unit; and

the velocity identification unit identifies the velocity of the target in the range direction using a function of an amplitude value V₀^{vrg} expressed by the velocity v_{P} of the SAR platform, the distance R₀, the synthetic aperture time τ, and a predicted velocity vᵣ′ of the target in the range direction, based on the predicted velocities in the range direction input by the predicted velocity input unit and the amplitude value computed from each azimuth-compressed data by the amplitude value computation unit.

The velocity identification unit identifies the velocity of the target in the range direction by using the function of the amplitude value V₀^{vrg} expressed by Equation 2:

$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 2 ]$$

where α is the arbitrary constant.

The predicted velocity input unit inputs each of a velocity vᵣ₁′ slower than the velocity vᵣ of the target in the range direction and a velocity vᵣ₂′ faster than the velocity vᵣ of the target in the range direction, as the predicted velocity in the range direction; and

the velocity identification unit substitutes into Equation 3 the predicted velocity vᵣ₁′ in the range direction and the predicted velocity vᵣ₂′ in the range direction input by the predicted velocity input unit, an amplitude value P₁ of the image of the target in the azimuth-compressed data generated by the reference function produced based on the predicted velocity vᵣ₁′ in the range direction, and an amplitude value P₂ of the image of the target in the azimuth-compressed data generated by the reference function produced based on the predicted velocity vᵣ₂′ in the range direction, thereby identifying the velocity vᵣ of the target in the range direction:

$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 3 ]$$

The predicted velocity input unit inputs each of at least two velocities slower than the velocity vᵣ of the target in the range direction and at least two velocities faster than the velocity vᵣ of the target in the range direction, as the predicted velocity in the range direction; and

the velocity identification unit computes a linear function of V₀^{vrg}=a₁vᵣ+a₂ (where a₁ and a₂ are constants) by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, computes a linear function of V₀^{vrg}=b₁vᵣ+b₂ (where b₁ and b₂ are constants) by the least square method, using the at least two predicted velocities in the range direction faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and identifies the velocity vᵣ in the range direction using the linear function of V₀^{vrg}=a₁vᵣ+a₂ and the linear function of V₀^{vrg}=b₁vᵣ+b₂.

The predicted velocity input unit newly inputs each of at least three predicted velocities in the range direction including at least one velocity slower than a velocity vᵣ of the target in the range direction and at least one velocity faster than the velocity vᵣ in the range direction, as the predicted velocity in the range direction;

based on the predicted velocities in the range direction newly input by the predicted velocity input unit and the velocity of the target in the azimuth direction identified by the velocity identification unit, the reference function production unit produces a reference function obtained from the relative distance, for each of the predicted velocities in the range direction, thereby newly producing a plurality of reference functions;

the azimuth compression process unit azimuth compresses the range-compressed data, based on each reference function of the plurality of reference functions newly produced by the reference function production unit, thereby newly generating a plurality of azimuth-compressed data;

the amplitude value computation unit computes an amplitude value of an image of the target in each azimuth-compressed data of the plurality of azimuth-compressed data newly generated by the azimuth compression process unit; and

the velocity identification unit computes a quadratic function of V₀^{vrg}=c₁vᵣ²+c₂vᵣ+c₃ (where c₁, c₂, and c₃ are constants) from the at least three predicted velocities in the range direction and the amplitude value computed from each azimuth-compressed data by the amplitude value computation unit, by a predetermined method, and then identifies a velocity in the range direction at a base of the quadratic function as the velocity vᵣ of the target in the range direction.

A target velocity identification apparatus according to the present invention is a target velocity identification apparatus which identifies a velocity of a target observed by a SAR (Synthetic Aperture Radar) including:

a data input unit which inputs range-compressed data obtained by range compressing data on the target observed by the SAR based on a velocity v_{P} of a SAR platform with the SAR mounted thereon, a distance R₀ between the SAR and the target at a center of a synthetic aperture, and a synthetic aperture time τ;

a predicted velocity input unit which inputs each of at least one velocity slower than a velocity vᵣ of the target in a range direction and at least one velocity faster than the velocity vᵣ of the target in the range direction, as a predicted velocity in the range direction;

a reference function production unit which produces a reference function obtained from a relative distance between the SAR and the target expressed based on the velocity v_{P} of the SAR platform and the velocity of the target, for each of a plurality of predicted velocities in the range direction input by the predicted velocity input unit, using a processing device, based on the plurality of predicted velocities in the range direction and a velocity of the target in an azimuth direction, thereby producing a plurality of reference functions;

an azimuth compression process unit which azimuth compresses the range-compressed data input by the data input unit, based on each reference function of the plurality of reference functions produced by the reference function production unit, thereby generating a plurality of azimuth-compressed data, using the processing device;

an amplitude value computation unit which computes an amplitude value of an image of the target in each azimuth-compressed data of the plurality of azimuth-compressed data generated by the azimuth compression process unit; and

a velocity identification unit which identifies the velocity of the target in the range direction using a function of an amplitude value V₀^{vrg} expressed by the velocity v_{P} of the SAR platform, the distance R₀, the synthetic aperture time τ, and a predicted velocity vᵣ′ of the target in the range direction, based on the plurality of predicted velocities in the range direction input by the predicted velocity input unit and the amplitude value computed from each azimuth-compressed data by the amplitude value computation unit.

The velocity identification unit identifies the velocity of the target in the range direction by using the function of the amplitude value V₀^{vrg} expressed by Equation 4:

$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 4 ]$$

where α is an arbitrary constant.

The predicted velocity input unit inputs each of a velocity vᵣ₁′ slower than the velocity vᵣ of the target in the range direction and a velocity vᵣ₂′ faster than the velocity vᵣ of the target in the range direction, as the predicted velocity in the range direction; and

the velocity identification unit substitutes into Equation 5 the predicted velocity vᵣ₁′ in the range direction and the predicted velocity vᵣ₂′ in the range direction input by the predicted velocity input unit, an amplitude value Pᵢ of the image of the target in the azimuth-compressed data generated by the reference function produced based on the predicted velocity vᵣ₁′ in the range direction, and an amplitude value P₂ of the image of the target in the azimuth-compressed data generated by the reference function produced based on the predicted velocity vᵢ-₂′ in the range direction, thereby identifying the velocity vᵣ of the target in the range direction:

$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 5 ]$$

The predicted velocity input unit inputs each of at least two velocities slower than the velocity vᵣ of the target in the range direction and at least two velocities faster than the velocity vᵣ of the target in the range direction, as the predicted velocity in the range direction; and

the velocity identification unit computes a linear function of V₀^{vrg}=a₁vᵣ+a₂ (where a₁ and a₂ are constants) by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, computes a linear function of V₀^{vrg}=b₁vᵣ+b₂ (where b₁ and b₂ are constants) by the least square method, using the at least two predicted velocities in the range direction faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and identifies the velocity vᵣ in the range direction from the linear function of V₀^{vrg}=a₁vᵣ+a₂ and the linear function of V₀^{vrg}=b₁vᵣ+b₂.

A target velocity identification apparatus according to the present invention is a target velocity identification apparatus which identifies a velocity of a target observed by a SAR (Synthetic Aperture Radar) including:

a data input unit which inputs range-compressed data obtained by range compressing data on the target observed by the SAR;

a predicted velocity input unit which inputs at least three predicted velocities including at least one velocity slower than a velocity vᵣ of the target in a range direction and at least one velocity faster than the velocity vᵣ of the target in the range direction, as predicted velocities in the range direction;

a reference function production unit which produces a reference function obtained from a relative distance between the SAR and the target expressed based on a velocity v_{P} of a platform with the SAR mounted thereon and the velocity of the target, for each of the predicted velocities in the range direction input by the predicted velocity input unit, based on the predicted velocities and a velocity of the target in an azimuth direction, using a processing device, thereby producing a plurality of reference functions;

an azimuth compression process unit which azimuth compresses the range-compressed data input by the data input unit, based on each reference function of the plurality of reference functions produced by the reference function production unit, thereby generating a plurality of azimuth-compressed data, using the processing device;

an amplitude value computation unit which computes an amplitude value of an image of the target in each azimuth-compressed data of the plurality of azimuth-compressed data generated by the azimuth compression process unit; and

a velocity identification unit which computes a quadratic function of V₀^{vrg}=c₁vᵣ²+c₂vᵣ+c₃ (where c₁, c₂, and c₃ are constants) from the at least three predicted velocities in the range direction input by the predicted velocity input unit and the amplitude value computed from each azimuth-compressed data by the amplitude value computation unit, by a predetermined method, and then identifies a velocity in the range direction at a base of the quadratic function as the velocity vᵣ of the target in the range direction, using the processing device.

A target velocity identification program according to the present invention is a target velocity identification program which identifies a velocity of a target observed by a SAR (Synthetic Aperture Radar), for causing a computer to execute:

a data input process of inputting data on the target observed by the SAR under observation conditions of a velocity v_{P} of a SAR platform with the SAR mounted thereon, a distance R₀ between the SAR and the target at a center of a synthetic aperture, a wavelength λ of an electric wave emitted from the SAR, and a synthetic aperture time τ;

a step size determination process of inputting the velocity v_{P} of the SAR platform, the distance R₀, the wavelength λ, of the electric wave, and the synthetic aperture time τ being the observation conditions of the data input in the data input process to a function of an amplitude value V₀^{vaz} expressed by the velocity v_{P} of the SAR platform, the distance R₀, the wavelength λ, of the electric wave, the synthetic aperture time τ, and a predicted velocity vₐ′ of the target in an azimuth direction to compute the amplitude value V₀^{vaz} corresponding to the predicted velocity vₐ′, identifying a range of the predicted velocity vₐ′ in the azimuth direction where the amplitude value V₀^{vaz} becomes a predetermined value or larger, and then sets a velocity width equal to or smaller than a velocity width of the identified range to a step size Δvₐ₁; and

an identification process execution process of identifying the velocity of the target in the azimuth direction using the step size Δvₐ₁ determined in the step size determination process.

In the step-size determination process, the velocity v_{P} of the SAR platform, the distance R₀, the wavelength λ of the electric wave, and the synthetic aperture time τ being the observation conditions of the data input in the data input process and a certain value as a velocity vₐ of the target are input to the function of the amplitude value V₀^{vaz} expressed by Equation 6, thereby computing the amplitude value V₀^{vaz} corresponding to the predicted velocity vₐ′:

$$\vert {V}_{0}^{vaz} ( {v}_{a} , {v}_{a}^{′} ) \vert = - \vert α \vert \sqrt{\frac{λ {R}_{0}}{\vert ( {v}_{a} - {v}_{a}^{′} ) ( {v}_{a} + {v}_{a}^{′} - 2 {v}_{P} ) \vert}} \cdot \vert {\int }_{0}^{τ \sqrt{\vert ( {v}_{a} - {v}_{a}^{′} ) ( {v}_{a} + {v}_{a}^{′} - 2 {v}_{P} ) \vert / λ {R}_{0}}} exp ( ∓ j {p}^{2} ) d p \vert \qquad [ Equation 6 ]$$

where α is an arbitrary constant, j is an imaginary unit, and a lowercase p is an integral operator.

In the step size determination process, based on the function expressed by Equation 6, a value larger than the amplitude value V₀^{vaz} at a top of a peak which is a second largest amplitude value in a graph is set to the predetermined value, the graph being obtained by plotting values of the amplitude value V₀ ^{vaz} for respective predicted velocities in the azimuth direction.

In the data input process, range-compressed data obtained by range compression is input, as the data on the target;

in the identification process execution process the computer is caused to execute:

a predicted velocity input process of inputting a predicted velocity of the target in a range direction, and also inputting the predicted velocities of the target in the azimuth direction for each step size Δvₐ₁ determined in the step size determination process;

a reference function production process of producing a reference function obtained from a relative distance between the SAR and the target, for each of the predicted velocities in the azimuth direction, based on the predicted velocity in the range direction and the predicted velocities in the azimuth direction input in the predicted velocity input process, thereby producing a plurality of reference functions;

an azimuth compression process of azimuth compressing the range-compressed data input in the data input process, based on each reference function of the plurality of reference functions produced in the reference function production process, thereby generating a plurality of azimuth-compressed data;

an amplitude value computation process of computing an amplitude value of an image of the target in each azimuth-compressed data of the plurality of azimuth-compressed data generated in the azimuth compression process; and

a velocity identification process of identifying that the velocity of the target in the azimuth direction falls within a range plus and minus a step size Δ vₐ₁/2 from one of the predicted velocities in the azimuth direction, the one of the predicted velocities in the azimuth direction being the predicted velocity used when the reference function used for generating the azimuth-compressed data having a maximum amplitude value of the image of the target computed in the amplitude value computation process has been produced in the reference function production process.

In the predicted velocity input process, the predicted velocities in the azimuth direction in the velocity range plus and minus the step size Δ vₐ₁/2 from the velocity identified in the velocity identification process are newly input, for each step size Δvₐ₂ narrower than the step size Δvₐ₁;

in the reference function production process, a reference function obtained from the relative distance is produced for each of the predicted velocities in the azimuth direction newly input in the predicted velocity input process, based on the predicted velocity in the range direction and the predicted velocities in the azimuth direction, thereby newly producing a plurality of reference functions;

in the azimuth compression process, the range-compressed data is azimuth compressed, based on each function of the plurality of reference functions newly produced in the reference function production process, thereby newly generating a plurality of azimuth-compressed data;

in the amplitude value computation process, an amplitude value of an image of the target in each azimuth-compressed data of the plurality of azimuth-compressed data newly generated in the azimuth compression process is newly computed; and

in the velocity identification process, one of the predicted velocities in the azimuth direction is identified as the velocity of the target in the azimuth direction, the one of the predicted velocities being the predicted velocity used when the reference function used for generating the azimuth-compressed data having a maximum amplitude value of the image of the target newly computed in the amplitude value computation process has been produced in the reference function production process.

In the predicted velocity input process, each of at least one velocity slower than a velocity vᵣ of the target in the range direction and at least one velocity faster than the velocity vᵣ of the target in the range direction is newly input, as the predicted velocity in the range direction;

in the reference function production process, based on the predicted velocities newly input in the predicted velocity process and the velocity of the target in the azimuth direction identified in the velocity identification process, a reference function obtained from the relative distance is produced for each of the predicted velocities in the range direction, thereby newly producing a plurality of reference functions;

in the azimuth compression process, the range-compressed data is azimuth compressed, based on each reference function of the plurality of reference functions newly produced in the reference function production process, thereby newly generating a plurality of azimuth-compressed data;

in the amplitude value computation process, an amplitude value of an image of the target in each azimuth-compressed data of the plurality of azimuth-compressed data newly generated in the azimuth compression process is computed; and

in the velocity identification process, the velocity of the target in the range direction is identified, using a function of an amplitude value V₀^{vrg} expressed by the velocity v_{P} of the SAR platform, the distance R₀, the synthetic aperture time τ, and a predicted velocity vᵣ′ of the target in the range direction, based on the predicted velocities in the range direction input in the predicted velocity input process and the amplitude value computed from each azimuth-compressed data in the amplitude value computation process.

In the velocity identification process, the velocity of the target in the range direction is identified by using the function of the amplitude value V₀^{vrg} expressed by Equation 7:

$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 7 ]$$

where α is the arbitrary constant.

In the predicted velocity input process, each of a velocity vᵣ₁′ slower than the velocity vᵣ of the target in the range direction and a velocity vᵣ₂′ faster than the velocity vᵣ of the target in the range direction is input, as the predicted velocity in the range direction; and

in the velocity identification process, the predicted velocity vᵣ₁′ in the range direction and the predicted velocity vᵣ₂′ in the range direction input in the predicted velocity input process, an amplitude value P₁ of the image of the target in the azimuth-compressed data generated by the reference function produced based on the velocity vᵣ₁′ in the range direction, and an amplitude value P₂ of the image of the target in the azimuth-compressed data generated by the reference function produced based on the velocity vᵣ₂′ in the range direction are substituted into Equation 8, thereby identifying the velocity vᵣ of the target in the range direction:

$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 8 ]$$

In the predicted velocity input process, each of at least two velocities slower than the velocity vᵣ of the target in the range direction and at least two velocities faster than the velocity vᵣ of the target in the range direction is input, as the predicted velocity in the range direction;

in the velocity identification process, a linear function of V₀^{vrg}=a₁vᵣ+a₂ (where a₁ and a₂ are constants) is computed by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, a linear function of V₀^{vrg}=b₁vᵣ+b₂ (where b₁ and b₂ are constants) is computed by the least square method, using the at least two predicted velocities in the range direction faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and the velocity vᵣ in the range direction is identified using the linear function of V₀^{vrg}=a₁vᵣ+a₂ and the linear function of V₀^{vrg}=b₁vᵣ+b₂.

In the predicted velocity input process, each of at least three predicted velocities in the range direction including at least one velocity slower than a velocity vᵣ of the target in the range direction and at least one velocity faster than the velocity vᵣ of the target in the range direction is newly input, as the predicted velocity in the range direction;

in the reference function production process, based on the predicted velocities newly input in the predicted velocity input process and the velocity of the target in the azimuth direction identified in the velocity identification process, a reference function obtained from the relative distance is produced for each of the predicted velocities in the range direction, thereby newly producing a plurality of reference functions;

in the azimuth compression process, the range-compressed data is azimuth compressed, based on each reference function of the plurality of reference functions newly produced in the reference function production process, thereby newly generating a plurality of azimuth-compressed data;

in the amplitude value computation process, an amplitude value of an image of the target in each azimuth-compressed data of the plurality of azimuth-compressed data newly generated in the azimuth compression process is computed; and

in the velocity identification process, a quadratic function of V₀^{vrg}=c₁vᵣ²+c₂vᵣ+c₃ (where c₁, c₂, and c₃ are constants) is computed from the at least three predicted velocities in the range direction and the amplitude value computed from each azimuth-compressed data in the amplitude value computation process, by a predetermined method, and a velocity in the range direction at a base of the quadratic function is identified as the velocity vᵣ of the target in the range direction.

A target velocity identification program according to the present invention is a target velocity identification program which identifies a velocity of a target observed by a SAR (Synthetic Aperture Radar) for causing a computer to execute:

a data input process of inputting range-compressed data obtained by range compressing data on the target observed by the SAR based on a velocity v_{P} of a SAR platform with the SAR mounted thereon, a distance R₀ between the SAR and the target at a center of a synthetic aperture, and a synthetic aperture time τ;

a predicted velocity input process of inputting each of at least one velocity slower than a velocity vᵣ of the target in a range direction and at least one velocity faster than the velocity vᵣ of the target in the range direction, as a predicted velocity in the range direction;

a reference function production process of producing a reference function obtained from a relative distance between the SAR and the target expressed based on the velocity v_{P} of the SAR platform and the velocity of the target, for each of a plurality of predicted velocities in the range direction input in the predicted velocity input process, based on the plurality of predicted velocities in the range direction and a velocity of the target in an azimuth direction, thereby producing a plurality of reference functions;

an azimuth compression process of azimuth compressing the range-compressed data input in the data input process, based on each reference function of the plurality of reference functions produced in the reference function production process, thereby generating a plurality of azimuth-compressed data;

an amplitude value computation process of computing an amplitude value of an image of the target in each azimuth-compressed data of the plurality of azimuth-compressed data generated in the azimuth compression process; and

a velocity identification process of identifying the velocity of the target in the range direction using a function of an amplitude value V₀^{vrg} expressed by the velocity v_{P} of the SAR platform, the distance R₀, the synthetic aperture time τ, and a predicted velocity vᵣ′ of the target in the range direction, based on the plurality of predicted velocities in the range direction input in the predicted velocity input process and the amplitude value computed from each azimuth-compressed data in the amplitude value computation process.

In the velocity identification process, the velocity of the target in the range direction is identified by using the function of the amplitude value V₀^{vrg} expressed by Equation 9:

$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 9 ]$$

where α is an arbitrary constant.

In the predicted velocity input process, each of a velocity vᵣ₁′ slower than the velocity vᵣ of the target in the range direction and a velocity vᵣ₂′ faster than the velocity vᵣ of the target in the range direction is input, as the predicted velocity in the range direction; and

in the velocity identification process, the predicted velocity vᵣ₁′ in the range direction and the predicted velocity vᵣ₂′ in the range direction input in the predicted velocity input process, an amplitude value P₁ of the image of the target in the azimuth-compressed data generated by the reference function produced based on the predicted velocity vᵣ₁′ in the range direction, and an amplitude value P₂ of the image of the target in the azimuth-compressed data generated by the reference function produced based on the predicted velocity vᵣ₂′ in the range direction are substituted into Equation 10, thereby identifying the velocity vᵣ of the target in the range direction:

$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 10 ]$$

In the predicted velocity input process, each of at least two velocities slower than the velocity vᵣ of the target in the range direction and at least two velocities faster than the velocity vᵣ of the target in the range direction is input, as the predicted velocity in the range direction; and

in the velocity identification process, a linear function of V₀^{vrg}=a₁vᵣ+a₂ (where a₁ and a₂ are constants) is computed by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, a linear function of V₀^{vrg}=b₁vᵣ+b₂ (where b₁ and b₂ are constants) is computed by the least square method, using the at least two velocities faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and the velocity vᵣ in the range direction is identified from the linear function of V₀^{vrg}+a₁vᵣ+a₂ and the linear function of V₀^{vrg}=b₁vᵣ+b₂.

A target velocity identification program according to the present invention is a target velocity identification program which identifies a velocity of a target observed by a SAR (Synthetic Aperture Radar) for causing a computer to execute:

a data input process of inputting range-compressed data obtained by range compressing data on the target observed by the SAR;

a predicted velocity input process of inputting at least three predicted velocities including at least one velocity slower than a velocity vᵣ of the target in a range direction and at least one velocity faster than the velocity vᵣ of the target in the range direction, as predicted velocities in the range direction;

a reference function production process of producing a reference function obtained from a relative distance between the SAR and the target expressed based on a velocity v_{P} of a platform with the SAR mounted thereon and the velocity of the target, for each of the predicted velocities in the range direction input in the predicted velocity input process, based on the predicted velocities and a velocity of the target in an azimuth direction, thereby producing a plurality of reference functions;

an azimuth compression process of azimuth compressing the range-compressed data input in the data input process, based on each reference function of the plurality of reference functions produced in the reference function production process, thereby generating a plurality of azimuth-compressed data;

an amplitude value computation process of computing an amplitude value of an image of the target in each azimuth-compressed data of the plurality of azimuth-compressed data generated in the azimuth compression process; and

a velocity identification process of computing a quadratic function of V₀^{vrg}=c₁vᵣ²+c₂vᵣ+c₃ (where c₁, c₂, and c₃ are constants) from the at least three predicted velocities in the range direction input in the predicted velocity input process and the amplitude value computed from each azimuth-compressed data in the amplitude value computation process, by a predetermined method, and then identifying a velocity in the range direction at a base of the quadratic function as the velocity vᵣ of the target in the range direction.

A target velocity identification method according to the present invention is a target velocity identification method of identifying a velocity of a target observed by a SAR (Synthetic Aperture Radar) including:

a data input step of inputting data on the target observed by the SAR under observation conditions of a velocity v_{P} of a SAR platform with the SAR mounted thereon, a distance R₀ between the SAR and the target at a center of a synthetic aperture, a wavelength λ of an electric wave emitted from the SAR, and a synthetic aperture time τ;

a step size determination step of inputting the velocity v_{P} of the SAR platform, the distance R₀, the wavelength λ of the electric wave, and the synthetic aperture time τ being the observation conditions of the data input in the data input step to a function of an amplitude value V₀^{vaz} expressed by the velocity v_{P} of the SAR platform, the distance R₀, the wavelength λ of the electric wave, the synthetic aperture time τ, and a predicted velocity vₐ′ of the target in an azimuth direction to compute the amplitude value V₀^{vaz} corresponding to the predicted velocity vₐ′, identifying a range of the predicted velocity vₐ′ in the azimuth direction where the amplitude value V₀^{vaz} becomes a predetermined value or larger, and then setting a velocity width equal to or smaller than a velocity width of the identified range to a step size Δvₐ₁; and

an identification process execution step of identifying the velocity of the target in the azimuth direction using the step size Δvₐ₁ determined in the step size determination step.

### Advantageous Effect of Invention

In the target velocity identification apparatus according to the present invention, the step size of a predicted velocity to be input is set based on the function of an amplitude value, and the velocity of a target is identified based on the step size. With this arrangement, the approximate velocity of the target may be identified with a small amount of computation, without reducing the step size of the velocity.

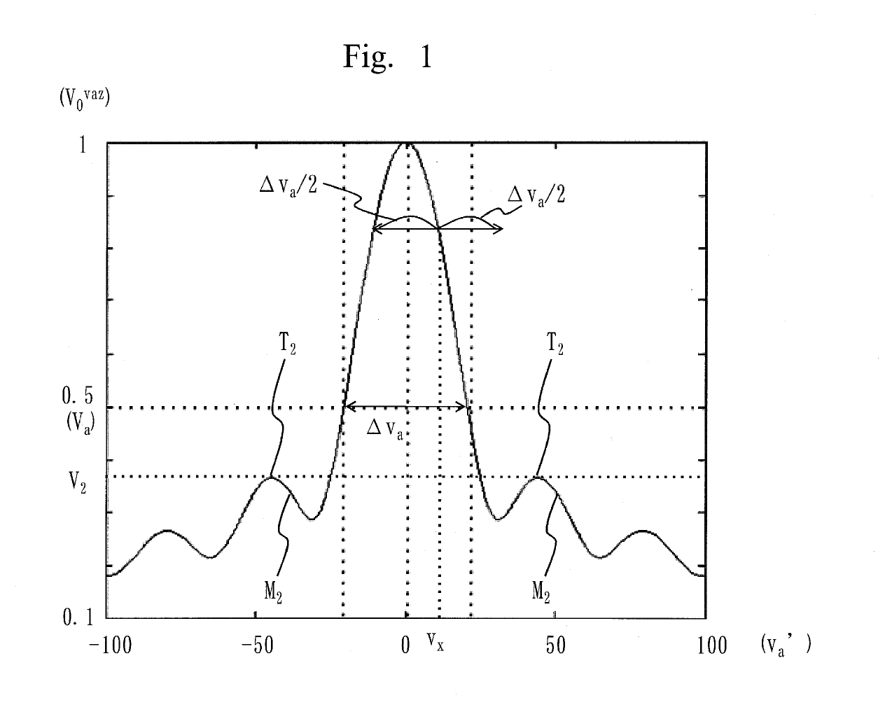

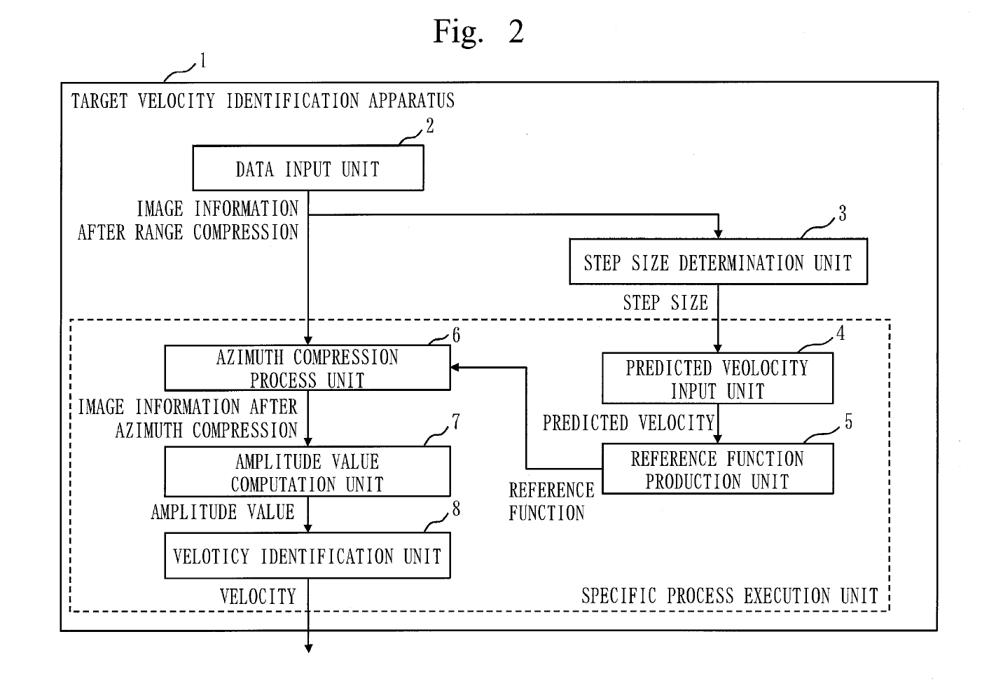

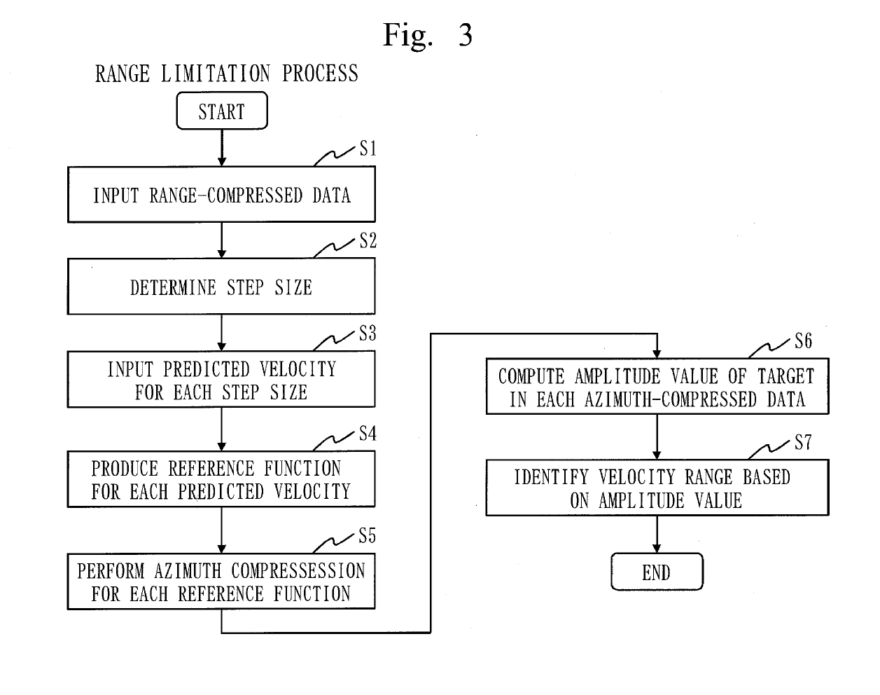

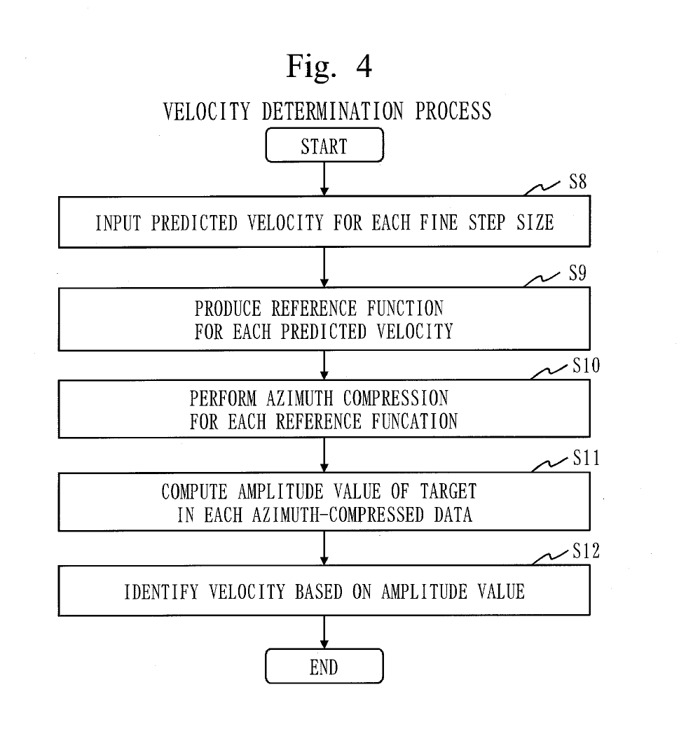

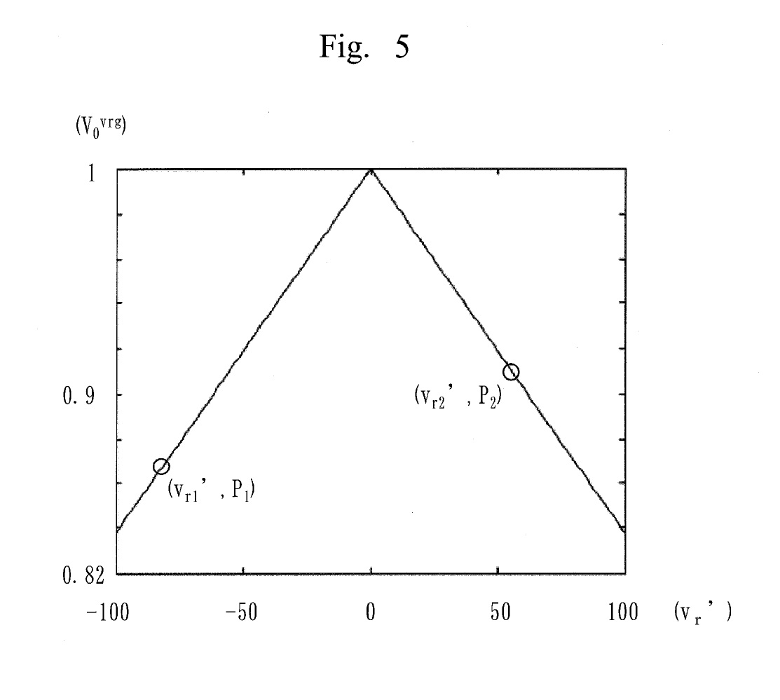

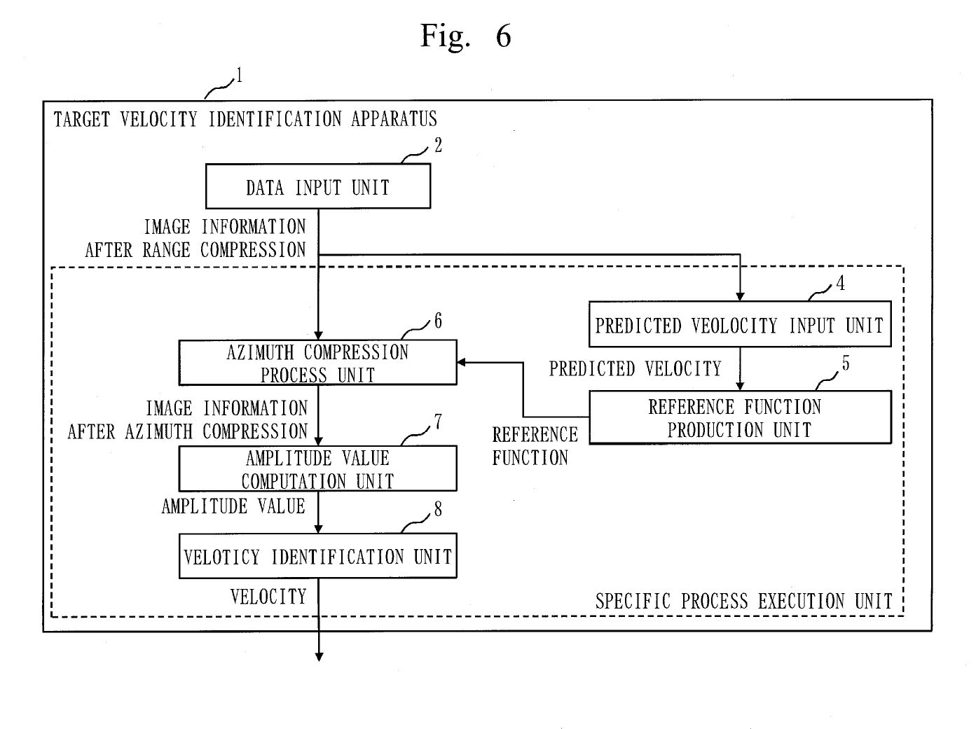

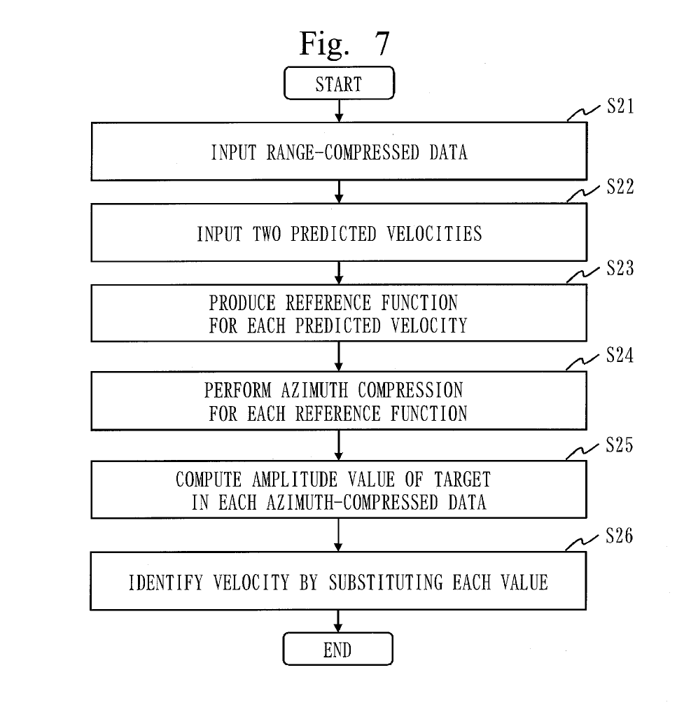

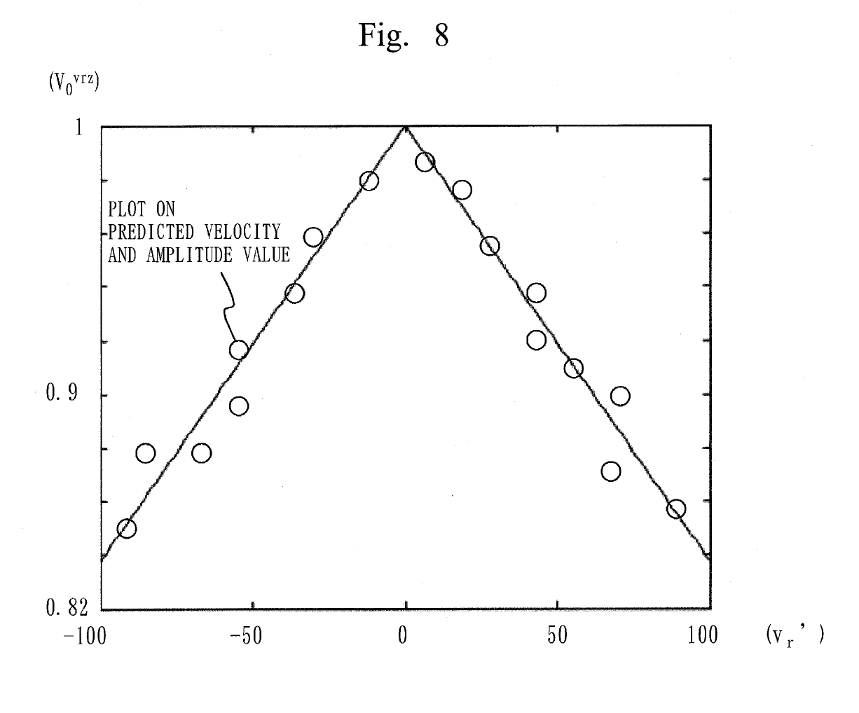

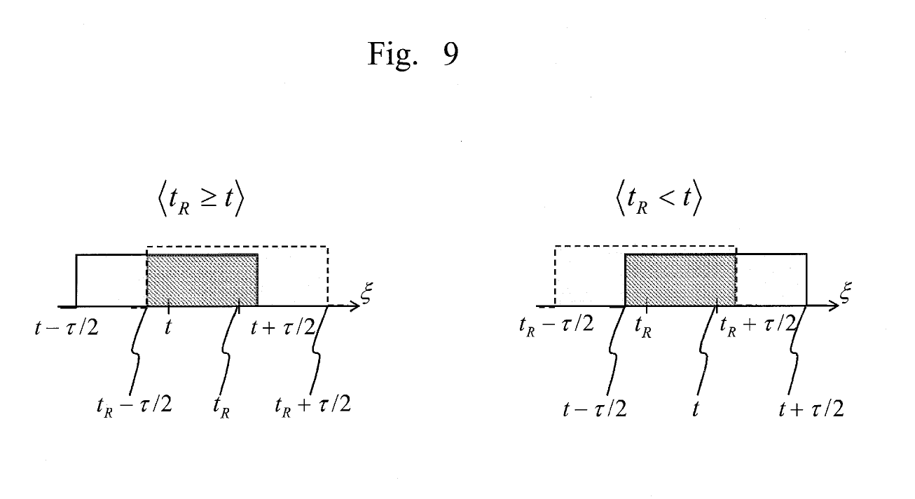

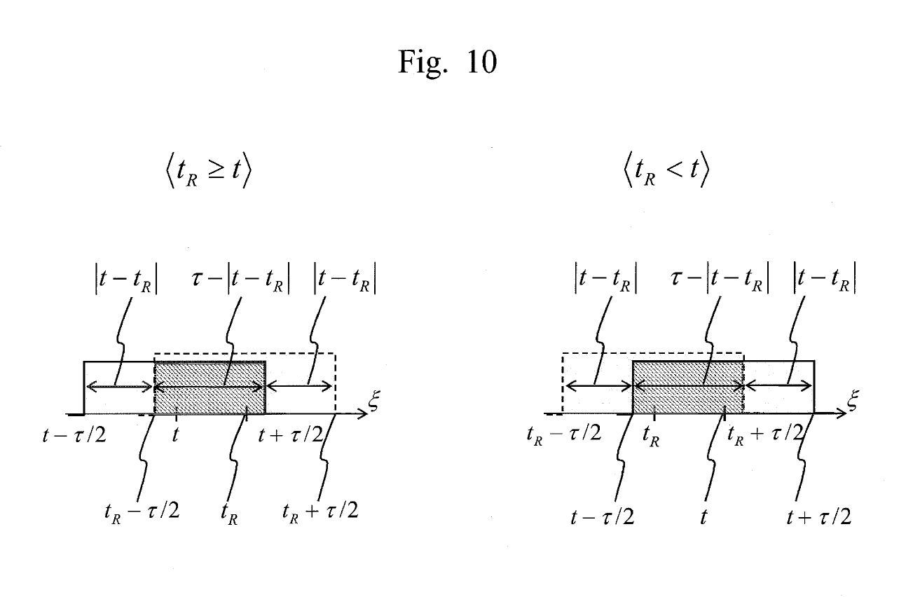

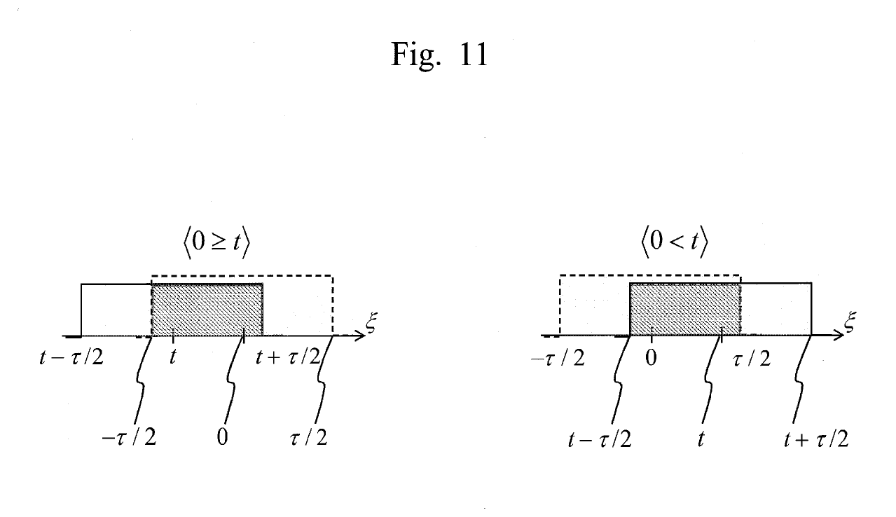

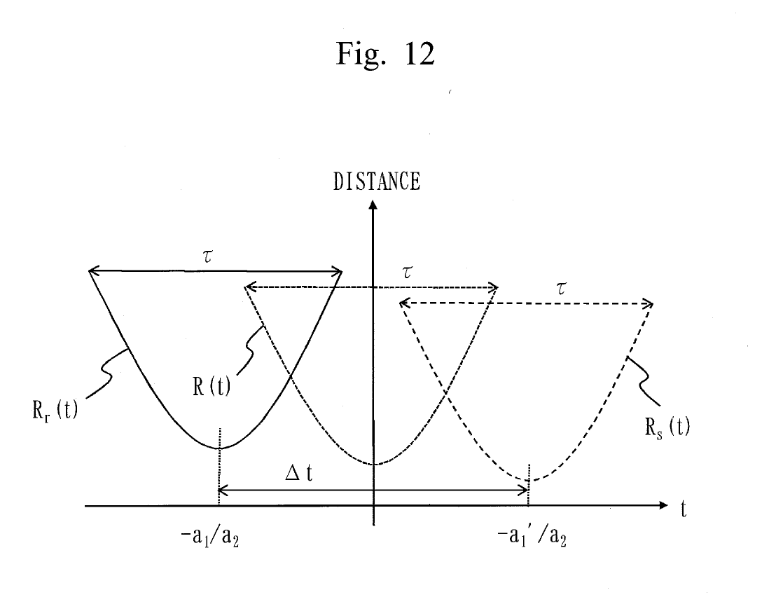

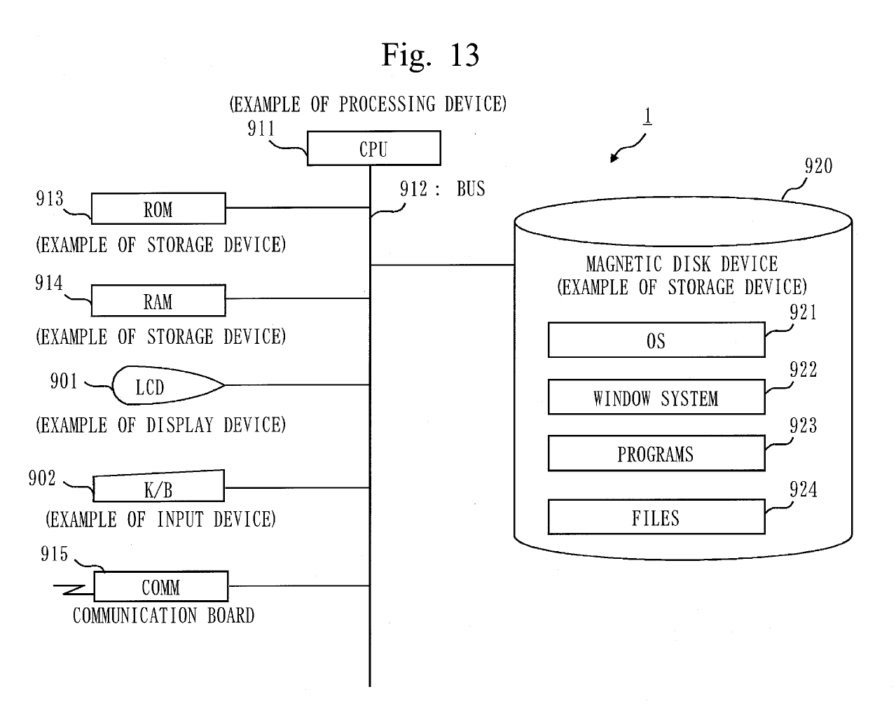

### BRIEF DESCRIPTION OF DRAWINGS

[FIG. 1] is a graph showing a relationship between a predicted target velocity vₐ′ in an azimuth direction and an amplitude value V₀^{vaz} obtained from Equation 20;

[FIG. 2] is a functional block diagram showing functions of a target velocity identification apparatus 1 according to a second embodiment;

[FIG. 3] is a flowchart showing an operation of the target velocity identification apparatus 1 according to the second embodiment;

[FIG. 4] is a flowchart showing an operation of the target velocity identification apparatus 1 according to the second embodiment;

[FIG. 5] is a graph showing a relationship between a predicted velocity vᵣ′ of a target in an azimuth direction and an amplitude value V₀^{vrg} obtained from Equation 22;

[FIG. 6] is a functional block diagram showing functions of a target velocity identification apparatus 1 according to a third embodiment;

[FIG. 7] is a flowchart showing an operation of the target velocity identification apparatus 1 according to the third embodiment;

[FIG. 8] is a graph showing a state where an amplitude value computed from a predicted velocity in a range direction is plotted;

[FIG. 9] includes explanatory diagrams each showing an integration range of an integral part A (in Equation 28) in Equation 27;

[FIG. 10] includes diagrams each explaining “τ−|t−t_{R}|;

[FIG. 11] includes explanatory diagrams each showing an integration range of an integral part B (in Equation 36) in Equation 35;

[FIG. 12] includes graphs showing a relative distance Rᵣ(t), a relative distance R(t), and a relative distance R,(t) expressed in Equation 54;

[FIG. 13] is a diagram showing an example of a hardware configuration of the target velocity identification apparatus 1.

### DESCRIPTION OF EMBODIMENTS

Embodiments of the invention will be described below, based on drawings.

In the following description, a processing device refers to a CPU 911 or the like that will be described later. A storage device refers to a ROM 913, a RAM 914, a magnetic disk 920, or the like that will be described later. An input device refers to a keyboard 902, a mouse 903, or the like that will be described later. That is, the processing device, the storage device, and the input device are hardware.

### First Embodiment

In a first embodiment, a case where a target is moving in an azimuth direction and a case where the target is moving in a range direction are assumed. A brief explanation will be given of the mathematical expression (function of an amplitude value) of a matched filter when azimuth compression is performed.

Generally, in a SAR image generation process, a received signal obtained by a SAR is range compressed and azimuth compressed, thereby generating image data. Each of the range compression and the azimuth compression refers to a process of computing the amplitude value (voltage) by inputting a reference function and the received signal into the matched filter.

The matched filter is expressed by Equation 11.

$${V}_{0} ( t ) = {\int }_{- ∞}^{∞} {V}^{*} ( ξ - t ) {V}_{r} ( ξ ) d ξ \qquad [ Equation 11 ]$$

where Vₒ is an amplitude value. t is time. V is a reference function. * indicates a complex conjugate. Vᵣ is a received signal. ξ is an operator for integration (integral operator).

The reference function for the azimuth compression is generally expressed by Equation 12.

$${V}_{0}^{az} ( t ) = A ( t ) exp \{ - j \frac{2 π}{λ} \cdot 2 R ( t ) \} \qquad [ Equation 12 ]$$

where Vₒ^{az} is an amplitude value. t is time. A (t) is a function which is 1 when −τ/2≦t≦τ/2, and 0 otherwise. τ is a synthetic aperture time. j is an imaginary unit. λ is the wavelength of an electric wave emitted from the SAR. R(t) is a relative distance between the SAR and the target at the time t.

Each of a target velocity vᵣ in the range direction, a target velocity vₐ in the azimuth direction, and a velocity v_{P} of a SAR platform with the SAR mounted thereon can respectively be defined as in Equation 13.

vᵣ(t)=v₀^{rg}+v₁^{rg}t+v₂^{rg}t²+ . . . ≈v₀^{rg}

vₐ(t)=v₀^{az}+v₁^{az}t+v₂^{az}t²+ . . . ≈v₀^{az}

v_{P}(t)=v₀^{P}+v₁^{P}t+v₂^{P}t²+ . . . ≈v₀^{P} [Equation 13]

Referring to Equations 13, each velocity is assumed to be composed of a constant component alone, or is assumed to be the velocity of a uniform linear motion. Generally, the uniform linear motion is dominant in the motion of a vehicle, a ship, or the like. Thus, this assumption is reasonable when the velocity of the vehicle, the ship, or the like is handled. The rotation velocity of the earth or the like may be included in the target velocity in the range direction. Further, since the SAR platform moves in the azimuth direction, the velocity of the SAR platform is the velocity of the SAR platform in the azimuth direction.

Then, the relative distance R(t) between the SAR and the target can be expressed, as shown in Equation 14.

$$\begin{matrix}R ( t ) = \sqrt{{\{ {R}_{0} + {v}_{r} t \}}^{2} + {( {v}_{a} - {v}_{P} )}^{2} {t}^{2}} \\ \approx {R}_{0} + {v}_{r} t + \frac{{( {v}_{a} - {v}_{P} )}^{2}}{2 {R}_{0}} {t}^{2} \\ = {a}_{0} + {a}_{1} t + \frac{{a}_{2}}{2} {t}^{2}\end{matrix} \qquad [ Equation 14 ]$$

where R₀ is a distance between the target and the SAR at the center of the synthetic aperture. Further, a₀, a₁, and a₂ are as shown in Equation 15.

$${a}_{0} = {R}_{0} , {a}_{1} = {v}_{r} , {a}_{2} = \frac{{( {v}_{a} - {v}_{P} )}^{2}}{{R}_{0}} \qquad [ Equation 15 ]$$

Since only the terms related to t in Equation 14 are important, the reference function for the azimuth compression expressed by Equation 12 becomes as shown Equation 16 by using Equation 14.

$${V}_{0}^{az} ( t ) = A ( t ) exp \{ - j \frac{4 π}{λ} ( {a}_{1} t + \frac{{a}_{2}}{2} {t}^{2} ) \} \qquad [ Equation 16 ]$$

The received signal Vᵣ(t) can also be expressed as in Equation 17 in a similar manner to the reference function for the azimuth compression. Equation is different from the reference function in that a scale factor α which is determined by signal attenuation, scattering intensity, and the like of the signal is included in the received signal.

$${V}_{r} ( t ) = α A ( t ) exp \{ - j \frac{4 π}{λ} ( {a}_{0} + {a}_{1} t + \frac{{a}_{2}}{2} {t}^{2} ) \} \qquad [ Equation 17 ]$$

Let us consider a case where the target whose image was taken by the SAR is moving. In this case, the target velocity of the reference function and the target velocity of the received signal may not match. Then, the target velocity of the reference function and the target velocity of the received signal are expressed, using different variables.

First, let us consider a case where there is a difference between the target velocities in the azimuth direction target. For simplicity, it is assumed herein that the target velocities in the range direction are the same.

The target velocity vₐ in the azimuth direction is included in a₂ alone among a₀, a₁, and a₂, as shown in Equation 15. Then, a₂′ is defined as shown in Equation 18, with a true target velocity in the azimuth direction denoted by vₐ and a predicted target velocity in the azimuth direction denoted by vₐ′.

$${a}_{2}^{′} = \frac{{( {v}_{a}^{′} - {v}_{P} )}^{2}}{{R}_{0}} \qquad [ Equation 18 ]$$

Then, it is assumed that the target velocity in the azimuth direction of the reference function is the predicted velocity vₐ′ and the target velocity in the azimuth direction of the received signal is the true velocity vₐ. Then, the reference function expressed by Equation 16 becomes as shown in Equation 19. The received signal remains the same as expressed by Equation 17.

$${V}_{0}^{az} ( t ) = A ( t ) exp \{ - j \frac{4 π}{λ} ( {a}_{1} t + \frac{{a}_{2}^{′}}{2} {t}^{2} ) \} \qquad [ Equation 19 ]$$

When the complex conjugate of the reference function V₀^{az} expressed in Equation 19 and the received signal Vᵣ expressed in Equation 17 are substituted into the matched filter expressed by Equation 11, as V* and Vᵣ, respectively, for equation transformation, Equation 20 is obtained. A method of deriving Equation 20 will be described in a following embodiment.

$$\vert {V}_{0}^{vaz} ( {v}_{a} , {v}_{a}^{′} ) \vert = - \vert α \vert \sqrt{\frac{λ {R}_{0}}{\vert ( {v}_{a} - {v}_{a}^{′} ) ( {v}_{a} + {v}_{a}^{′} - 2 {v}_{P} ) \vert}} \cdot \vert {\int }_{0}^{τ \sqrt{\vert ( {v}_{a} - {v}_{a}^{′} ) ( {v}_{a} + {v}_{a}^{′} - {2}_{{v}_{P}} ) \vert / λ {R}_{0}}} exp ( ∓ j {p}^{2} ) d p \vert \qquad [ Equation 20 ]$$

where j is the imaginary unit. p is an integral operator.

Now, let us consider a case where there is a difference between the target velocities in the range direction. For simplicity, it is assumed herein that the target velocities in the azimuth direction are the same.

The target velocity vᵣ in the range direction is included in a₁ alone among a₀, a₁, and a₂, as shown in Equation 15. Then, a₁′=vᵣ′ is defined, with a true target velocity in the range direction denoted by vᵣ and a predicted target velocity in the range direction denoted by vᵣ′.

Then, it is assumed that the target velocity in the range direction of the reference function is the predicted velocity vᵣ′ and the target velocity in the range direction of the received signal is the true velocity vᵣ. Then, the reference function expressed by Equation 16 becomes as shown in Equation 21. The received signal remains the same as expressed by Equation 17.

$${V}_{0}^{rg} ( t ) = A ( t ) exp \{ - j \frac{4 π}{λ} ( {a}_{1}^{′} t + \frac{{a}_{2}}{2} {t}^{2} ) \} \qquad [ Equation 21 ]$$

When the complex conjugate of the reference function V₀^{az} expressed in Equation 21 and the received signal Vᵣ expressed in Equation 17 are substituted into the matched filter expressed by Equation 11 as V* and Vᵣ, respectively, for equation transformation, Equation 22 is obtained. A method of deriving Equation 22 will be described in a following embodiment.

$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 22 ]$$

By obtaining Equations 20 and 22, it becomes possible to identify the target velocity with high precision and with a small amount of computation.

### Second Embodiment

A method of efficiently identifying the target velocity in the azimuth direction with a small amount of computation based on Equation 20 will be described in a second embodiment.

In a refocus ISAR, the smaller the variation size of the predicted velocity of a target is set when producing a plurality of reference functions for azimuth compression, the higher precision of identifying the target velocity can be obtained. However, the smaller the variation size of the predicted target velocity is set, the more the amount of computation will be needed.

When identifying the velocity of a target using the refocus ISAR, it has not been possible so far to obtain a guideline indicating to what extent the variation size of the predicted target velocity should to be set. By using Equation 20, however, the variation size of the predicted target velocity can be determined when identifying the target velocity using the refocus ISAR.

FIG. 1 is a graph showing a relationship between the predicted target velocity vₐ′ in the azimuth direction and an amplitude value V₀^{vaz} obtained from Equation 20. Referring to FIG. 1, the predicted target velocity vₐ′ in the azimuth direction is plotted on a horizontal axis, and the amplitude value V₀^{vaz} is plotted on a vertical axis.

Referring to FIG. 1, the maximum value of the amplitude value V₀^{vaz} is normalized to 1. The true target velocity vₐ in the azimuth direction is set to 0. Further, referring to FIG. 1, the velocity V_{P} of the SAR platform with the SAR mounted thereon, the distance R₀ between the SAR and the target at the center of the synthetic aperture, the wavelength λ of the electric wave emitted from the SAR, and the synthetic aperture time τ are set to predetermined values.

In the following description, a positive velocity in the azimuth direction is the velocity in a travelling direction of the SAR platform, while a negative velocity in the azimuth direction is a velocity in a direction opposite to the travelling direction of the SAR platform. A positive velocity in the range direction is a velocity in the range direction that separates from the SAR, while a negative velocity in the range direction is a velocity in the range direction that approaches the SAR.

Even if the true target velocity vₐ in the azimuth direction is set to any value other than 0, the shape of the graph shown in FIG. 1 remains unchanged, and the graph just shifts in parallel to a horizontal axis direction. In other words, when the velocity V_{P} of the SAR platform, the distance R₀, the wavelength λ of the electric wave, and the synthetic aperture time τ are determined, the shape of the graph is determined. The velocity V_{P} of the SAR platform, the distance R₀, the wavelength λ of the electric wave, and the synthetic aperture time τ are observation conditions of a SAR image and are information that have been determined when the SAR image is taken. Then, the true target velocity vₐ in the azimuth direction is set to an arbitrary value, and a graph showing a relationship between the predicted target velocity vₐ′ in the azimuth direction and the amplitude value V₀^{vaz} is drawn, as shown in FIG. 1.

Next, an amplitude value Vₐ that is larger than an amplitude value V₂ of a top T₂ of a peak M₂ having a second highest maximum amplitude value in the drawn graph is arbitrarily selected. Herein, the amplitude value of 0.5, which is a half of the maximum amplitude value, is selected as the amplitude value Vₐ, for example. A range of the predicted velocity vₐ′ whose amplitude values are equal to or larger than the selected amplitude value Vₐ is identified, and then a velocity width Δvₐ of the range of the predicted velocity vₐ′ is identified.

Reference functions are produced by varying the predicted target velocity using this velocity width Δvₐ as a step size (variation size). Then, when azimuth compression is performed based on at least one (at most two) of the reference functions, amplitude values of Vₐ or larger are obtained.

Assume herein that the amplitude value is equal to or larger than vₐ for a predicted velocity vₓ. Then, it can be seen that the target velocity falls within the velocity range plus and minus Δvₐ/2 from the predicted velocity vₓ. In other words, by producing the reference functions by varying the predicted target velocity using the velocity width Δvₐ as the step size, the range of the target velocity may be narrowed down to the velocity width Δvₐ.

Then, reference functions are produced by varying the predicted velocity in the narrowed velocity range using a fine step size to identify the target velocity with high precision.

FIG. 2 is a functional block diagram showing functions of a target velocity identification apparatus 1 in the second embodiment.

The target velocity identification apparatus 1 includes a data input unit 2, a step size determination unit 3, a predicted velocity input unit 4, a reference function production unit 5, an azimuth compression process unit 6, an amplitude value computation unit 7, and a velocity identification unit 8. The predicted velocity input unit 4, the reference function production unit 5, the azimuth compression process unit 6, the amplitude value computation unit 7, and the velocity identification unit 8 are referred to as a specific process execution unit.

FIGS. 3 and 4 are flowcharts showing operation of the target velocity identification apparatus 1 in the second embodiment. The operation of the target velocity identification apparatus 1 is broadly divided into two stages. A first stage is a process shown in FIG. 3, which is a range limitation process for narrowing down the velocity range of the target. A second stage is a process shown in FIG. 4, which is a velocity determination process for determining the target velocity in the narrowed-down velocity range.

The range limitation process will be described.

(S1: Data Input Process)

The data input unit 2 inputs range-compressed data (image information after range compression) obtained by range compressing data on the target observed by the SAR, using the input device, and then stores in the storage device.

The data input unit 2 inputs the velocity V_{P} of the SAR platform with the SAR mounted thereon, the distance R₀ between the SAR and the target at the center of the synthetic aperture, the wavelength λ of the electric wave emitted from the SAR, and the synthetic aperture time τ, together with the range-compressed data. All of the input information is observation information obtained when the image of the target was taken.

The range-compressed data may be data generated by azimuth decompressing (performing the reverse computation of azimuth compression) azimuth-compressed data using a reference function employed when the azimuth compression is performed.

(S2: Step Size Determination Process)

The step size determination unit 3 computes, as a step size, the velocity width Δvₐ (hereinafter referred to as a step size Δvₐ₁) from the velocity V_{P} of the SAR platform, the distance R₀, the wavelength of the electric wave, and the synthetic aperture time τ input in (S1), and Equation 20, as described above, using the processing device.

The step size determination unit 3 may compute the step size by substituting the velocity V_{P} of the SAR platform, the distance R₀, the wavelength of the electric wave, the synthetic aperture time τ, and an arbitrary velocity vₐ in the azimuth direction into Equation 20. Alternatively, the step size determination unit 3 may draw a graph to compute the step size from the graph, as described based on FIG. 1.

(S3: Predicted Velocity Input Process)

The predicted velocity input unit 4 inputs the predicted target velocity in the range direction and a plurality of predicted target velocities in the azimuth direction, using the processing device, and then stores in the storage device.

The predicted velocity input unit 4 inputs an arbitrary one of velocities in the range direction that may be assumed by the target. On the other hand, the predicted velocity input unit 4 inputs the predicted velocities in the azimuth direction in a velocity range that may be assumed by the target, for each step size Δvₐ₁ that has been determined in (S2).

The range of the velocities that may be assumed by the target may be determined, according to the target intended such as a ship, a vehicle, or the like. When the target achieves the velocity of 100 km/h, for example, the range of the velocities that may be assumed by the target is a range from −100 km/h to +100 km/h Thus, in this case, the predicted velocity input unit 4 inputs an appropriate one of the velocities within the range from −100 km/h to +100 km/h as the predicted velocity in the range direction. When the step size is 20 km/h, for example, the predicted velocity input unit 4 inputs the velocity in the range from −100 km/h to +100 km/h, for each 20 km/h, as the predicted velocity in the azimuth direction. In other words, the predicted velocity input unit 4 inputs, for example, −100 km/h, −80 km/h, −60 km/h, +60 km/h, +80 km/h, and +100 km/h, as the velocities in the azimuth direction.

(S4: Reference Function Production Process)

The reference function production unit 5 produces a reference function (e.g., refer to Equation 16) for each predicted velocity in the azimuth direction, using the processing device, based on the predicted velocity in the range direction and the plurality of predicted velocities in the azimuth direction that have been input in (S3). With this arrangement, a plurality of reference functions is produced.

(S5: Azimuth Compression Process)

The azimuth compression process unit 6 azimuth compresses the range-compressed data that has been input in (S1), based on each reference function that has been produced in (S4), thereby generating a plurality of azimuth-compressed data, using the processing device.

(S6: Amplitude Value Computation Process)

The amplitude value computation unit 7 computes the amplitude value of the image of the target in each azimuth-compressed data that has been generated in (S5), using the processing device.

(S7: Velocity Identification Process)

The velocity identification unit 8 identifies the reference function used for generating the azimuth-compressed data whose amplitude value of the image of the target that has been computed in (S6) is largest, using the processing device. Further, the velocity identification unit 8 identifies the predicted velocity in the azimuth direction used when the identified reference function has been produced, using the processing device. Then, the velocity identification unit 8 identifies a range plus and minus Δvₐ₁/2 from the identified predicted velocity, as the range of the target velocity in the azimuth direction.

A velocity determination process will be described.

(S8: Predicted Velocity Input Process) The predicted velocity input unit 4 inputs a plurality of the predicted velocities in the azimuth direction in the velocity range that has been identified in (S7), for each step size Δvₐ₂ that is narrower than the step size Δvₐ₁, and then stores in the storage device.

The step size Δvₐ₂ may be determined, according to a precision level at which the target velocity is desired to be identified. To take an example, the step size Δvₐ₁ is 1 km/h, 0.1 km/h, or the like.

(S9: Reference Function Production Process)

The reference function production unit 5 produces a reference function (e.g., refer to Equation 16) for each predicted velocity in the azimuth direction, based on the predicted velocity in the range direction that has been input in (S3) and the plurality of the predicted velocities in the azimuth direction that have been input in (S8), using the processing device. With this arrangement, a plurality of reference functions is produced.

(S10: Azimuth Compression Process) The azimuth compression process unit 6 azimuth compresses the range-compressed data input in (S1) based on each reference function that has been produced in (S9), thereby generating a plurality of azimuth-compressed data, using the processing device.

(S11: Amplitude Value Computation Process)

The amplitude value computation unit 7 computes the amplitude value of the image of the target in each azimuth-compressed data that has been generated in (S10), using the processing device.

(S12: Velocity Identification Process)

The velocity identification unit 8 identifies the reference function used for generating the azimuth-compressed data whose amplitude value of the image of the target that has been computed in (S11) is largest, using the processing device. Then, the velocity identification unit 8 identifies the predicted velocity in the azimuth direction used when the identified reference function has been produced, as the target velocity in the azimuth direction, using the processing device.

As described above, by using Equation 20, the target velocity identification apparatus 1 according to the second embodiment can determine the step size of the predicted velocity of a target to be used for identifying the target velocity using the refocus ISAR.

The target velocity identification apparatus 1 according to the second embodiment in particular makes a search with coarse precision using a coarse step size determined based on Equation 20, thereby narrowing down the range of the target velocity in the azimuth direction. Then, the target velocity identification apparatus 1 searches the narrowed-down range alone with high precision, using a fine step size, thereby allowing identification of the target velocity in the azimuth direction with precision of the same level as that used when the target velocity identification apparatus 1 searches an entire range of predicted velocities with high precision. In other words, the target velocity identification apparatus 1 may identify the velocity with high precision and with a small amount of computation.

In the above description, it has been assumed that one predicted velocity in the range direction is input in (S3). This is because the shape of the graph to be drawn based on Equation 20 is not affected by the target velocity in the range direction. Thus, only one arbitrary predicted velocity in the range direction suffices.

However, depending on the predicted velocity in the range direction that has been input in step (S3), a precise velocity may not be able to be identified, due to influence of noise, or the like. Then, a plurality of predicted velocities in the range direction may be input in (S3), and a reference function may be produced for each velocity in the azimuth direction and for each velocity in the range direction in each of (S4 and S9). Then, the amplitude value of the target in azimuth-compressed image data generated based on each reference function may be computed in each of (S6 and S11), and then, the mean value of the computed amplitude values may be computed for each predicted velocity in the azimuth direction.

With this arrangement, the influence of the noise or the like that has affected some signals indicating the velocities in the range direction may be reduced. Precision of velocity identification may be increased.

### Third Embodiment

A method of efficiently identifying the target velocity in the range direction with a small amount of computation based on Equation 22 will be described in a third embodiment.

FIG. 5 is a graph showing a relationship between the predicted target velocity vᵣ′ in the azimuth direction and an amplitude value V₀^{vrg} obtained from Equation 22. Referring to FIG. 5, the predicted target velocity vᵣ′ in the range direction is plotted on a horizontal axis, and the amplitude value V₀^{vrg} is plotted on a vertical axis.

Referring to FIG. 5, the maximum value of the amplitude value V₀^{vrg} is normalized to 1. The true target velocity vᵣ in the range direction is set to 0. Further, referring to FIG. 1, the velocity V_{P} of the SAR platform with the SAR mounted thereon, the distance R₀ between the SAR and the target at the center of the synthetic aperture, the wavelength λ of the electric wave emitted from the SAR, and the synthetic aperture time τ are each set to a predetermined value.

As seen from Equation 22 and FIG. 5, Equation 22 represents a linear function including absolute values. The amplitude value of Equation 22 becomes a maximum value when the predicted target velocity vᵣ′ is the true target velocity vᵣ in the range direction.

Then, by combining a linear function of the predicted target velocity vᵣ′ slower than the true target velocity vᵣ (on the side of FIG. 5 where the predicted velocity vᵣ′ is negative) and a linear function of the predicted target velocity vᵣ′ faster than the true target velocity vᵣ (on the side of FIG. 5 where the predicted velocity vᵣ′ is positive) to obtain the true target velocity vᵣ in the range direction whose amplitude value V₀^{vrg} becomes the maximum value. Assume that the amplitude value of a predicted velocity vᵣ₁′ in FIG. 5 is set to P₁, and the amplitude value of a predicted velocity vᵣ₂′ in FIG. 5 is set to P₂, for example. Then, the amplitude values P₁ and P₂ can be expressed as shown in Equation 23. It is set that vᵣ₁′<vᵣ<vᵣ₂′.

$${P}_{1} = \vert α \vert ( τ - \frac{{R}_{0}}{{v}_{P}^{2}} ( {v}_{r} - {v}_{r 1}^{′} ) ) \\ {P}_{2} = \vert α \vert ( τ + \frac{{R}_{0}}{{v}_{P}^{2}} ( {v}_{r} - {v}_{r 2}^{′} ) ) \qquad [ Equation 23 ]$$

Then, Equation 24 is obtained from Equation 23.

$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 24 ]$$

where α is an arbitrarily set value. The velocity v_{P} of the SAR platform, the distance R₀, and the synthetic aperture time τ are observation conditions of the SAR image. Thus, the velocity vₚ of the SAR platform, the distance R₀, and the synthetic aperture time τ are known in advance. For that reason, if the predicted velocity vᵣ₁′, the amplitude value P₁, the predicted velocity vᵣ₂′, and the amplitude value P₂ are known, the true target velocity Vᵣ in the range direction may be computed, based on Equation 24.

FIG. 6 is a functional block diagram showing functions of a target velocity identification apparatus 1 according to the third embodiment. The target velocity identification apparatus 1 shown in FIG. 6 has a same configuration as the target velocity identification apparatus 1 shown in FIG. 2 except that the target velocity identification apparatus 1 in FIG. 6 does not include the step size determination unit 3.

FIG. 7 is a flowchart showing operation of the target velocity identification apparatus 1 according to the third embodiment.

(S21: Data Input Process)

The data input unit 2 inputs range-compressed data obtained by range compressing data on the target observed by the SAR, using the input device, and then stores in the storage device, as in (S1) in FIG. 3.

(S22: Predicted Velocity Input Process)

The predicted velocity input unit 4 inputs two predicted target velocities in the range direction and the velocity in the azimuth direction, using the processing device, and then stores in the storage device.

With respect to the predicted velocities in the range direction, the predicted velocity input unit 4 inputs the velocity vᵣ₁′ slower than the true velocity vᵣ and the velocity vᵣ₂′ faster than the true velocity vᵣ one by one. The velocity slower than the true velocity vᵣ is a velocity whose velocity value is smaller than that of the true velocity vᵣ. When the true velocity vᵣ is 0 km/h, for example, the velocity vᵣ₁ is −10 km/h, −50 km/h, or the like that is smaller than 0 km/h. On the other hand, the velocity faster than the true velocity vᵣ is a velocity whose velocity value is larger than that of the true velocity vᵣ. When the true velocity vᵣ is 0 km/h, for example, the velocity vᵣ₂ is 10 km/h, 50 km/h, or the like that is larger than 0 km/h. When the velocity that may be assumed by the target ranges from −100 km/h to +100 km/h, for example, the velocity that is slower than the true velocity vᵣ should be set to −150 km/h, and that velocity that is faster than the true velocity vᵣ should be set to +150 km/h.

With respect to the velocity in the azimuth direction, the predicted velocity input unit 4 inputs the velocity identified by the method described in the second embodiment or the like. An arbitrary predicted velocity may be input as the velocity in the azimuth direction, but it is desirable to input the precise velocity.

(S23: Reference Function Production Process)

The reference function production unit 5 produces a reference function (e.g., refer to Equation 16) for each predicted velocity in the range direction, based on the two predicted velocities in the range direction and the velocity in the azimuth direction that have been input in (S22), using the processing device. With this arrangement, two reference functions are produced.

(S24: Azimuth Compression Process)

The azimuth compression process unit 6 azimuth compresses the range-compressed data that has been input in (S21), based on each reference function that has been produced in (S23), thereby generating two azimuth-compressed data, using the processing device.

(S25: Amplitude Value Computation Process)

The amplitude value computation unit 7 computes the amplitude value of the image of the target in each of the two azimuth-compressed data that have been generated in (S24), using the processing device. With this arrangement, the amplitude value P₁ and the amplitude value P₂ are computed.

(S26: Velocity Identification Process)

The velocity identification unit 8 substitutes the velocity v_{P}, the distance R₀, the synthetic aperture time ti that have been input in (S21), the velocities vᵣ₁′ and vᵣ₂′ that have been input in (S22), and the amplitude values P₁ and P₂ that have been computed in (S25) into Equation 24 to compute the true velocity vᵣ, using the processing device.

As described above, in the target velocity identification apparatus 1 according to the third embodiment, the target velocity in the range direction may be identified and just by generating azimuth-compressed image data based on two predicted velocities and by using Equation 22. That is, the target velocity identification apparatus 1 may identify the velocity with a small amount of computation.

In the above description, the predicted velocity in the range direction slower than the true velocity vᵣ and the predicted velocity in the range direction faster than the true velocity vᵣ are input one by one, and then the linear function of the predicted target velocity slower than the true velocity vᵣ and the linear function of the predicted target velocity faster than the true velocity vᵣ are combined to obtain the true velocity vᵣ.

However, when the predicted velocity in the range direction and the amplitude value computed from the predicted velocity in the range direction are plotted, the clear linear function as shown in FIG. 5 may not able to be obtained due to influence of noise or the like. Variations may occur, as shown in FIG. 8. Then, two or more velocities slower than the true velocity vᵣ and two or more velocities faster than the true velocity vᵣ may be input, as predicted velocities in (S22). Then, a linear function V₀^{vrg}=a₁vᵣ+a₂ (where a₁ and a₂ are constants) for a velocity slower than the true velocity vᵣ is computed by a least square method, using the two or more velocities slower than the true velocity vᵣ and an amplitude value computed from each of these velocities. Similarly, a linear function V₀^{vrg}=b₁vᵣ+b₂ (where b₁ and b₂ are constants) for a velocity faster than the true velocity vᵣ is computed by the least square method, using the two or more velocities faster than the true velocity vᵣ and an amplitude value computed from each of these velocities. With this arrangement, each of the linear functions may be more precisely identified. Then, the identified two linear functions may be combined to compute the true velocity vᵣ.

Alternatively, three or more predicted velocities including at least one velocity slower than the true velocity vᵣ and at least one velocity faster than the true velocity vᵣ may be input in (S22). Then, a quadratic function of V₀^{vrg}=c₁vᵣ²+c₂vᵣ+c₃ (where c₁, c₂ and c₃ are constants) is computed by the least square method or spline interpolation using the three or more predicted velocities, and a predicted velocity at the base of the computed quadratic function may be identified as the true velocity vᵣ.

For determination of the true velocity vᵣ, the larger a difference in amplitude values in the range of velocities that may be assumed by the target is, the more an error caused by the influence of noise or the like may be reduced. Referring to FIG. 5, for example, an amplitude value in the range of velocities from −100 km/h to +100 km/h ranges approximately from 0.84 to 1. That is, a difference between amplitude values is 0.16. A small difference between the amplitude values in the range of the velocities means that the linear function has a gentle inclination. Consequently, if just a small error is included in the amplitude value due to noise or the like, a large error will be produced in the identified velocity.

Then, the SAR platform may be so designed that the difference in the amplitude values in the range of the velocities is large, or the inclination of the linear function is sharp. Specifically, in order to make the inclination of the linear function to be sharp, the SAR platform should be so designed that the distance R₀ is large and the velocity v_{P} of the SAR platform is small to increase the value of R₀/v_{P}² in Equation 22.

### Fourth Embodiment

A method of deriving Equation 20 and Equation 22 will be described in a fourth embodiment.

Each of Equation 20 and Equation 22 is an equation about azimuth compression. Range compression and the azimuth compression are similar in that each of the range compression and the azimuth compression are a process of computing an amplitude value (voltage) by inputting a reference function and a received signal to the matched filter.

Then, in the fourth embodiment, the range compression will be first explained for reference (refer to Non Patent Literature 1). Then, secondly, the azimuth compression which is the main issue will be explained. More specifically, a description will be directed to a case where there is no difference between the true target velocity and the predicted target velocity, as Section 2-1. A description will be directed to a case where there is a difference between the true target velocity and the predicted target velocity in the azimuth direction, as Section 2-2. A description will be directed to a case where there is a difference between the true target velocity and the predicted target velocity in the range direction, as Section 2-3. Further, thirdly, Equation 20 is derived from the result of Section 2-2, and Equation 22 is derived from the result of Section 2-3, as a summary.

<1. Range Compression>

As described in the first embodiment, the matched filter is expressed by Equation 11. A reference function V(t) for the range compression is expressed as shown Equation 25, and a received signal Vᵣ(t) is expressed as shown Equation 26.

$$\begin{matrix}V ( t ) = A ( t ) exp \{ j 2 π ( {f}_{c} t + \frac{K}{2} {t}^{2} ) \} & [ Equation 25 ] \\ {V}_{r} ( t ) = α V ( t - {t}_{R} ) & [ Equation 26 ]\end{matrix}$$

where V is an amplitude value. t is time. A (t) is a function which is 1 when −τ/2≦t≦τ/2, and 0 otherwise. In addition, i is the synthetic aperture time. j is the imaginary unit. f_{c} is a center frequency. K is a chirp rate. α is the scale factor. t_{R} is a time delay where a signal transmitted from the SAR gets back due to reflection at the target.

When the complex conjugate of the reference function V expressed in Equation 25 and the received signal Vᵣ expressed in Equation 26 are substituted into the matched filter expressed by Equation 11 as V* and Vᵣ, respectively, Equation 27 is obtained.

$${V}_{0} ( t ) = α exp ( j 2 π {f}_{c} t ) exp ( - j 2 π {f}_{c} {t}_{R} ) \cdot {\int }_{- ∞}^{∞} A ( ξ - t ) A ( ξ - {t}_{R} ) exp \{ j 2 π \frac{K}{2} ( t - {t}_{R} ) ( 2 ξ - t - {t}_{R} ) \} d ξ \qquad [ Equation 27 ]$$

FIG. 9 includes diagrams each explaining an integration range of an integral part A (expressed by Equation 28) in Equation 27. As shown in FIG. 9, Equation 28 is computed in two cases where t_{R}≧t and t_{R}<t.

$$( A ) = {\int }_{- ∞}^{∞} A ( ξ - t ) A ( ξ - {t}_{R} ) exp \{ j 2 π \frac{K}{2} ( t - {t}_{R} ) ( 2 ξ - t - {t}_{R} ) \} d ξ \qquad [ Equation 28 ]$$

When t_{R}≧t, Equation 28 is computed as shown in Equation 29.

$$\begin{matrix}( A ) = {\int }_{{t}_{R} - τ / 2}^{t + τ / 2} A ( ξ - t ) A ( ξ - {t}_{R} ) \\ exp \{ j 2 π \frac{K}{2} ( t - {t}_{R} ) ( 2 ξ - t - {t}_{R} ) \} d ξ \\ = \frac{sin \{ π K ( t - {t}_{R} ) ( τ - \vert t - {t}_{R} \vert ) \}}{π K ( t - {t}_{R} )}\end{matrix} \qquad [ Equation 29 ]$$

On the other hand, when t_{R}<t, Equation 28 is computed as shown in

Equation 30.

$$\begin{matrix}( A ) = {\int }_{t - τ / 2}^{{t}_{R} + τ / 2} A ( ξ - t ) A ( ξ - {t}_{R} ) \\ exp \{ j 2 π \frac{K}{2} ( t - {t}_{R} ) ( 2 ξ - t - {t}_{R} ) \} d ξ \\ = \frac{sin \{ π K ( t - {t}_{R} ) ( τ - \vert t - {t}_{R} \vert ) \}}{π K ( t - {t}_{R} )}\end{matrix} \qquad [ Equation 30 ]$$

That is, in both of the cases where t_{R}≧t and t_{R}<t, the same result is obtained. Thus, Equation 27 can be transformed to Equation 31. Equation 31 represents a sine function.

$$\begin{matrix}{V}_{0} ( t ) = α exp ( j 2 π {f}_{c} t ) exp ( - j 2 π {f}_{c} {t}_{R} ) \cdot \\ \frac{sin \{ π K ( t - {t}_{R} ) ( τ - \vert t - {t}_{R} \vert ) \}}{π K ( t - {t}_{R} )} \\ = α ( τ - \vert t - {t}_{R} \vert ) exp ( j 2 π {f}_{c} t ) exp ( - j 2 π {f}_{c} {t}_{R} ) \cdot \\ \frac{sin \{ π K ( t - {t}_{R} ) ( τ - \vert t - {t}_{R} \vert ) \}}{π K ( t - {t}_{R} ) ( τ - \vert t - {t}_{R} \vert )}\end{matrix} \qquad [ Equation 31 ]$$

Physical interpretation of “τ−|t−t_{R}|” will be described.

FIG. 10 includes diagrams explaining “τ−|t−t_{R}|”. As shown in FIG. 10, τ−|t−t_{R}| represents how much the reference function and the received signal are correlated. Different from the received signal indicative of an observation amount, start and end times of the reference function can arbitrarily be set. For that reason, once the correlation amount of a SAR system is set, the correlation amount is not changed by a position of a focal point t in “|t−t_{R}|”. Thus, “τ−|t−t_{R}|” can be treated as a constant. That is, “t” in “τ−|t−t_{R}” can be considered to be disassociated from the time t.

Consequently, by changing “t” to“t₀” in “τ−|t−t_{R}|”, Equation 31 can be transformed to Equation 32.

$${V}_{0} ( t ) = α ( τ = - \vert {t}_{0} - {t}_{R} \vert ) exp ( j2π {f}_{c} t ) exp ( - j2π {f}_{c} {t}_{R} ) \cdot \frac{sin \{ π K ( t - {t}_{R} ) ( τ - \vert {t}_{0} - {t}_{R} \vert ) \}}{π K ( t - {t}_{R} ) ( τ - \vert {t}_{0} - {t}_{R} \vert )} \qquad [ Equation 32 ]$$

In a common SAR system, a reference function and a received signal correlates to each other for the most part. Thus, |t₀−t_{R}| is negligibly small as compared with τ (|t₀−t_{R}|<<τ). Thus, Equation 32 can be transformed to Equation 33.

$${V}_{0} ( t ) \approx α τ exp ( j2π {f}_{c} t ) exp ( - j2π {f}_{c} {t}_{R} ) \cdot \frac{sin \{ πτ K ( t - {t}_{R} ) \}}{πτ K ( t - {t}_{R} )} \qquad [ Equation 33 ]$$

<2. Azimuth Compression>

<2-1. Case Where There is No Difference between True Velocity and Predicted Velocity of Target>

Computation will be carried out in the same way as described in Section 1.

As described in the first embodiment, the matched filter is expressed by Equation 11. The reference function for the azimuth compression is expressed as shown in Equation 16, and the received signal is expressed as shown in Equation 17.

The term a₀ in the reference function expressed in Equation 16 is independent of the time t, and is not important for the matched filter. Then, by removing the term a₀ in the reference function expressed by Equation 16, Equation 34 is obtained.

$${V}^{az} ( t ) = A ( t ) exp \{ - j \frac{4 π}{λ} ( {a}_{1} t + \frac{{a}_{2}}{2} {t}^{2} ) \} \qquad [ Equation 34 ]$$

Since the component of the term a₀ is included in the received signal, the term a₀ is left in the received signal expressed by Equation 17, without being removed from the received signal.

When the complex conjugate of the reference function V^{az} expressed in Equation 34 and the received signal Vᵣ expressed in Equation 17 are substituted into the matched filter expressed by Equation 11 as V* and Vᵣ, respectively, Equation 35 is obtained.

$$\begin{matrix}{V}_{0} ( t ) = {\int }_{- ∞}^{∞} {V}^{*} ( ξ - t ) {V}_{r} ( ξ ) d ξ \\ = α exp ( j \frac{4 π}{λ} {a}_{0} ) exp ( - j \frac{4 π}{λ} {a}_{1} t ) \cdot \\ {\int }_{- ∞}^{∞} A ( ξ - t ) A ( ξ ) exp \{ j \frac{4 π}{λ} \frac{{a}_{2}}{2} t ( 2 ξ - t ) \} d ξ\end{matrix} \qquad [ Equation 35 ]$$

FIG. 11 includes diagrams each explaining an integration range of an integral part B (expressed by Equation 36) in Equation 35. As shown in FIG. 11, Equation 36 is computed in two cases where 0≧t and 0<t.

$$( B ) = {\int }_{- ∞}^{∞} A ( ξ - t ) A ( ξ ) exp \{ j \frac{4 π}{λ} \frac{{a}_{2}}{2} t ( 2 ξ - t ) \} d ξ \qquad [ Equation 36 ]$$

When 0≧t, Equation 36 is computed as shown in Equation 37.

$$\begin{matrix}( B ) = {\int }_{- τ / 2}^{t + τ / 2} A ( ξ - t ) A ( ξ ) exp \{ j \frac{4 π}{λ} \frac{{a}_{2}}{2} t ( 2 ξ - t ) \} d ξ \\ {\int }_{- τ / 2}^{t + τ / 2} exp \{ - j w ( 2 ξ - t ) \} d ξ ( ∵ w = \frac{4 π}{λ} \frac{{a}_{2}}{2} ) \\ = \frac{1}{2} {\int }_{- ( t + τ )}^{t + τ} exp \{ - j wu \} d u ( ∵ u = 2 ξ - t ) \\ = \frac{sin \{ \frac{2 π}{λ} {a}_{2} t ( τ - \vert t \vert ) \}}{\frac{2 π}{λ} {a}_{2} t}\end{matrix} \qquad [ Equation 37 ]$$

On the other hand, when 0<t, Equation 36 is computed as shown in

Equation 38.

$$\begin{matrix}( B ) = {\int }_{t - τ / 2}^{τ / 2} A ( ξ - t ) A ( ξ ) exp \{ j \frac{4 π}{λ} \frac{{a}_{2}}{2} t ( 2 ξ - t ) \} d ξ \\ {\int }_{t - τ / 2}^{τ / 2} exp \{ - j w ( 2 ξ - t ) \} d ξ ( ∵ w = \frac{4 π}{λ} \frac{{a}_{2}}{2} ) \\ = \frac{1}{2} {\int }_{- ( τ - t )}^{τ - t} exp \{ - j wu \} d u ( ∵ u = 2 ξ - t ) \\ = \frac{sin \{ \frac{2 π}{λ} {a}_{2} t ( τ - \vert t \vert ) \}}{\frac{2 π}{λ} {a}_{2} t}\end{matrix} \qquad [ Equation 38 ]$$

That is, in both of the cases where 0≧t and 0<t, the same result is obtained. Thus, Equation 35 can be transformed to Equation 39.

$$\begin{matrix}{V}_{0} ( t ) = α exp ( j \frac{4 π}{λ} ( {a}_{0} + {a}_{1} t ) ) \cdot \frac{sin \{ \frac{2 π}{λ} {a}_{2} t ( τ - \vert t \vert ) \}}{\frac{2 π}{λ} {a}_{2} t} \\ = α ( τ - \vert t \vert ) exp ( j \frac{4 π}{λ} ( {a}_{0} + {a}_{1} t ) ) \cdot \frac{sin \{ \frac{2 π}{λ} {a}_{2} t ( τ - \vert t \vert ) \}}{\frac{2 π}{λ} {a}_{2} t ( τ - \vert {t}_{0} \vert )}\end{matrix} \qquad [ Equation 39 ]$$

“τ−|t|” can be physically interpreted in a similar manner to “τ−|t−t_{R}|” described in Section 1. Consequently, by changing “t” to“t₀” in “τ−|t|”, Equation 39 can be transformed to Equation 40.

$${V}_{0} ( t ) = α ( τ - \vert {t}_{0} \vert ) exp ( j \frac{4 π}{λ} ( {a}_{0} + {a}_{1} t ) ) \cdot \frac{sin \{ \frac{2 π}{λ} {a}_{2} t ( τ - \vert {t}_{0} \vert ) \}}{\frac{2 π}{λ} {a}_{2} t ( τ - \vert {t}_{0} \vert )} \qquad [ Equation 40 ]$$

In the common SAR system, a reference function and a received signal correlate to each other for the most part. Thus, |t₀| is negligibly small as compared with τ (|t₀|<<τ). Thus, Equation 40 can be transformed to Equation 41.

$${V}_{0} ( t ) \approx ατ exp ( j \frac{4 π}{λ} ( {a}_{0} + {a}_{1} t ) ) \cdot \frac{sin \{ \frac{2 π}{λ} τ {a}_{2} t \}}{\frac{2 π}{λ} τ {a}_{2} t} \qquad [ Equation 41 ]$$

<2-2. Case Where There is Difference between True Target Velocity and Predicted Target Velocity in Azimuth Direction>

As described in the first embodiment, the target velocity vₐ in the azimuth direction is included in a₂ alone among a₀, a₁, and a₂. Then, a₂′ is defined as shown in Equation 18, with the true target velocity in the azimuth direction denoted by vₐ and the predicted target velocity in the azimuth direction denoted by vₐ′. Then, it is assumed that the target velocity in the azimuth direction of the reference function is the predicted velocity vₐ′ and the target velocity in the azimuth direction of the received signal is the true velocity vₐ. Then, the reference function V^{az} expressed by Equation 34 is transformed to the reference function V^{vaz} expressed by Equation 42.

$${V}^{vaz} ( t ) = A ( t ) exp \{ - j \frac{4 π}{λ} ( {a}_{1} t + \frac{{a}_{2}^{′}}{2} {t}^{2} ) \} \qquad [ Equation 42 ]$$

From now on, computation will be carried out in the same way as described in Section 2-1.

First, when the complex conjugate of the reference function V^{vaz} expressed in Equation 42 and the received signal Vᵣ expressed in Equation 17 are substituted into the matched filter expressed by Equation 11 as V* and Vᵣ, respectively, Equation 43 is obtained.

$${V}_{0} ( t ) = α exp ( - j \frac{4 π}{λ} \{ {a}_{0} + {a}_{1} t - \frac{{a}_{2} {a}_{2}^{′}}{2 Δ} {t}^{2} \} ) \cdot {\int }_{- ∞}^{∞} A ( ξ - t ) A ( ξ ) exp \{ - j \frac{2 π}{λ} {Δ ( ξ + \frac{{a}_{2}^{′}}{Δ} t )}^{2} \} d ξ \qquad [ Equation 43 ]$$

An integral part C (expressed by Equation 44) in Equation 43 is computed in two cases where 0≦t and 0<t, as explained based on FIG. 11.

$$( C ) = {\int }_{- ∞}^{∞} A ( ξ - t ) A ( ξ ) exp \{ - j \frac{2 π}{λ} {Δ ( ξ + \frac{{a}_{2}^{′}}{Δ} t )}^{2} \} d ξ \qquad [ Equation 44 ]$$

When Δ=a₂−a₂′ and 0≧t, Equation 44 is computed as shown in Equation 45.

$$\begin{matrix}( C ) = {\int }_{- τ / 2}^{t + τ / 2} A ( ξ - t ) A ( ξ ) exp \{ - j \frac{2 π}{λ} {Δ ( ξ + \frac{{a}_{2}^{′}}{Δ} t )}^{2} \} d ξ \\ = \frac{1}{\sqrt{\frac{2 π}{λ} \vert Δ \vert}} \{ \begin{matrix}{\int }_{0}^{( τ / 2 + {a}_{2}^{′} t / \vert Δ \vert ) \sqrt{2 π \vert Δ \vert / λ}} exp ( - j {w}^{2} ) d w + \\ {\int }_{0}^{\{ τ / 2 + ( 1 - {a}_{2}^{′} / \vert Δ \vert ) t \} \sqrt{2 π \vert Δ \vert / λ}} exp ( - j {w}^{2} ) d w\end{matrix} \}\end{matrix} \qquad [ Equation 45 ]$$

This Equation corresponds to a case where Δ<0. When Δ≧0, Equation 44 is computed as shown in Equation 46.

$$\begin{matrix}( C ) = {\int }_{- τ / 2}^{t + τ / 2} A ( ξ - t ) A ( ξ ) exp \{ - j \frac{2 π}{λ} {Δ ( ξ + \frac{{a}_{2}^{′}}{Δ} t )}^{2} \} d ξ \\ = \frac{1}{\sqrt{\frac{2 π}{λ} \vert Δ \vert}} \{ \begin{matrix}{\int }_{0}^{( τ / 2 - {a}_{2}^{′} t / \vert Δ \vert ) \sqrt{2 π \vert Δ \vert / λ}} exp ( - j {w}^{2} ) d w + \\ {\int }_{0}^{\{ τ / 2 + ( 1 - {a}_{2}^{′} / \vert Δ \vert ) t \} \sqrt{2 π \vert Δ \vert / λ}} exp ( - j {w}^{2} ) d w\end{matrix} \}\end{matrix} \qquad [ Equation 46 ]$$

On the other hand, when 0<t, Equation 44 is computed as shown in one of Equation 47 and Equation 48, according to the sign of Δ.

$$\begin{matrix}( C ) = {\int }_{t - τ / 2}^{τ / 2} A ( ξ - t ) A ( ξ ) exp \{ - j \frac{2 π}{λ} {Δ ( ξ + \frac{{a}_{2}^{′}}{Δ} t )}^{2} \} d ξ = \frac{- 1}{\sqrt{\frac{2 π}{λ} \vert Δ \vert}} \{ \begin{matrix}{\int }_{0}^{( τ / 2 - {a}_{2}^{′} t / \vert Δ \vert ) \sqrt{2 π \vert Δ \vert / λ}} exp ( - j {w}^{2} ) d w + \\ {\int }_{0}^{\{ τ / 2 - ( 1 - {a}_{2}^{′} / \vert Δ \vert ) t \} \sqrt{2 π \vert Δ \vert / λ}} exp ( - j {w}^{2} ) d w\end{matrix} \} & [ Equation 47 ] \\ ( C ) = {\int }_{t - τ / 2}^{τ / 2} A ( ξ - t ) A ( ξ ) exp \{ - j \frac{2 π}{λ} {Δ ( ξ + \frac{{a}_{2}^{′}}{Δ} t )}^{2} \} d ξ = \frac{- 1}{\sqrt{\frac{2 π}{λ} \vert Δ \vert}} \{ \begin{matrix}{\int }_{0}^{( τ / 2 + {a}_{2}^{′} t / \vert Δ \vert ) \sqrt{2 π \vert Δ \vert / λ}} exp ( - j {w}^{2} ) d w + \\ {\int }_{0}^{\{ τ / 2 - ( 1 + {a}_{2}^{′} / \vert Δ \vert ) t \} \sqrt{2 π \vert Δ \vert / λ}} exp ( - j {w}^{2} ) d w\end{matrix} \} & [ Equation 48 ]\end{matrix}$$

Next, the sign of t is noted. Then, each of Equation 45 and Equation 47 can be transformed to Equation 49.

$$( C ) = - \sqrt{\frac{λ}{2 π \vert Δ \vert}} \{ \begin{matrix}{\int }_{0}^{( τ / 2 - {a}_{2}^{′} \vert t \vert / \vert Δ \vert ) \sqrt{2 π \vert Δ \vert / λ}} exp ( - j {w}^{2} ) d w + \\ {\int }_{0}^{\{ τ / 2 - ( 1 - {a}_{2}^{′} / \vert Δ \vert ) \vert t \vert \} \sqrt{2 π \vert Δ \vert / λ}} exp ( - j {w}^{2} ) d w\end{matrix} \} ( Δ < 0 ) \qquad [ Equation 49 ]$$

This equation corresponds to the case where Δ<0. When Δ≧0, each of Equation 46 and Equation 48 can be transformed to Equation 50.

$$( C ) = \sqrt{\frac{λ}{2 π \vert Δ \vert}} \{ \begin{matrix}{\int }_{0}^{( τ / 2 + {a}_{2}^{′} \vert t \vert / \vert Δ \vert ) \sqrt{2 π \vert Δ \vert / λ}} exp ( - j {w}^{2} ) d w + \\ {\int }_{0}^{\{ τ / 2 - ( 1 + {a}_{2}^{′} / \vert Δ \vert ) \vert t \vert \} \sqrt{2 π \vert Δ \vert / λ}} exp ( - j {w}^{2} ) d w\end{matrix} \} ( Δ \geq 0 ) \qquad [ Equation 50 ]$$

Then, by substituting Equation 49 to the value of the integral of Equation 43, Equation 43 can be transformed to Equation 51. By substituting Equation 50 to the value of the integral of Equation 43, Equation 52, Equation 43 can be transformed to Equation 52.

$$\begin{matrix}{V}_{0}^{vaz} ( t ) = - α exp ( - j \frac{4 π}{λ} \{ {a}_{0} + {a}_{1} t - \frac{{a}_{2} {a}_{2}^{′}}{2 Δ} {t}^{2} \} ) \cdot \sqrt{\frac{λ}{2 π \vert Δ \vert}} \{ \begin{matrix}{\int }_{0}^{( τ / 2 - {a}_{2}^{′} \vert t \vert / \vert Δ \vert ) \sqrt{2 π \vert Δ \vert / λ}} exp ( - j {w}^{2} ) d w + \\ {\int }_{0}^{\{ τ / 2 - ( 1 - {a}_{2}^{′} / \vert Δ \vert ) \vert t \vert \} \sqrt{2 π \vert Δ \vert / λ}} exp ( - j {w}^{2} ) d w\end{matrix} \} ( Δ < 0 ) & [ Equation 51 ] \\ {V}_{0}^{vaz} ( t ) = - α exp ( - j \frac{4 π}{λ} \{ {a}_{0} + {a}_{1} t - \frac{{a}_{2} {a}_{2}^{′}}{2 Δ} {t}^{2} \} ) \cdot \sqrt{\frac{λ}{2 π \vert Δ \vert}} \{ \begin{matrix}{\int }_{0}^{( τ / 2 + {a}_{2}^{′} \vert t \vert / \vert Δ \vert ) \sqrt{2 π \vert Δ \vert / λ}} exp ( - j {w}^{2} ) d w + \\ {\int }_{0}^{\{ τ / 2 - ( 1 + {a}_{2}^{′} / \vert Δ \vert ) \vert t \vert \} \sqrt{2 π \vert Δ \vert / λ}} exp ( - j {w}^{2} ) d w\end{matrix} \} ( Δ \geq 0 ) & [ Equation 52 ]\end{matrix}$$

When t=0 and the absolute value is taken, Equation 53 can be obtained.

$$\vert {V}_{0}^{vaz} ( t = 0 ) \vert = 2 \vert α \vert \sqrt{\frac{λ}{2 π \vert Δ \vert}} \vert {\int }_{0}^{τ / 2 \sqrt{2 π \vert Δ \vert / λ}} exp ( - j {w}^{2} ) d w \vert = \vert α \vert \sqrt{\frac{λ}{\vert Δ \vert}} \vert {\int }_{0}^{τ \sqrt{\vert Δ \vert / λ}} exp ( ∓ j {p}^{2} ) d p \vert ( ∵ p = w \sqrt{2 / π} ) \qquad [ Equation 53 ]$$

<2-3. Case Where There is Difference between True Target Velocity and Predicted Target Velocity in Range Direction>

As described in the first embodiment, the target velocity vₐ in the range direction is included in a₁ alone among a₀, a₁, and a₂. Then, a₁′ is defined to be equal to vᵣ′, with the true target velocity in the azimuth direction denoted by vᵣ and the predicted target velocity in the azimuth direction denoted by vᵣ′. Then, it is assumed that the target velocity in the range direction of the reference function is the predicted velocity vᵣ′ and the target velocity in the range direction of the received signal is the true velocity vᵣ.

Then, a relative distance Rᵣ(t) of the received signal, a relative distance R(t) of the reference function, and a relative distance Rₛ(t) between the target and the SAR when the target is not moving in the range direction can be expressed as shown in Equation 54.

$${R}_{r} ( t ) = {a}_{0} + {a}_{1} t + \frac{{a}_{2}}{2} {t}^{2} = \frac{{a}_{2}}{2} {( t + \frac{{a}_{1}}{{a}_{2}} )}^{2} + {a}_{0} - \frac{{a}_{1}^{2}}{2 {a}_{2}} \\ R ( t ) = {a}_{0} + {a}_{1}^{′} t + \frac{{a}_{2}}{2} {t}^{2} = \frac{{a}_{2}}{2} {( t + \frac{{a}_{1}^{′}}{{a}_{2}} )}^{2} + {a}_{0} - \frac{{a}_{1}^{′ 2}}{2 {a}_{2}} \\ {R}_{s} ( t ) = {a}_{0} + \frac{{a}_{2}}{2} {t}^{2} \qquad [ Equation 54 ]$$

It is assumed in this case that the true target velocity in the azimuth direction and the predicted target velocity in the azimuth direction are the same. Herein, in particular, the target velocity in the azimuth direction is set to 0, and a₂ shown in Equation 15 is set to be equal to vₚ²/R₀, for simplicity.

FIG. 12 includes graphs showing the relative distance Rᵣ(t), the relative distance R(t), and the relative distance Rₛ(t) expressed in Equation 54.

As shown in FIG. 12, base positions of the relative distance Rᵣ(t), the relative distance R(t), and the relative distance Rₛ(t) are deviated. A shift in an R(t) axis, or the shift in the range direction between the relative distance Rᵣ(t) and the relative distance R(t) is a constant, and is independent of a time t. Thus, this shift is not important. Then, it is considered in this case that a difference between the true target velocity in the range direction and the predicted target velocity in the range direction will cause a shift on a time axis, or the shift in the azimuth direction alone between the relative distance Rᵣ(t) and the relative distance R(t). Then, a shift amount At on the time axis is given by Equation 55.

$$Δ t = \frac{{a}_{1} - {a}_{1}^{′}}{{a}_{2}} \\ ( {a}^{′} = {a}_{1} - {a}_{2} Δ t ) \qquad [ Equation 55 ]$$

When a₁′ shown in Equation 55 is substituted into the relative distance R(t), Equation 56 is obtained.

$$R ( t ) = \frac{{a}_{2}}{2} {( t + \frac{{a}_{1}}{{a}_{2}} - Δ t )}^{2} + {a}_{0} - \frac{{( {a}_{1} - {a}_{2} Δ t )}^{2}}{2 {a}_{2}} = \frac{{a}_{2}}{2} {( t - Δ t )}^{2} + {a}_{1} ( t - Δ t ) + {a}_{0} + \frac{Δ t ( 2 {a}_{1} - {a}_{2} Δ t )}{2} \qquad [ Equation 56 ]$$

Then, the reference function V^{az} expressed in Equation 34 can be converted to a reference function V^{vrg} expressed in Equation 57, based on the relative distance R(t) expressed by Equation 55.

$${V}^{vrg} ( t ) = A ( t - Δ t ) exp \{ - j \frac{4 π}{λ} ( {a}_{1} ( t - Δ t ) + \frac{{a}_{2}}{2} {( t - Δ t )}^{2} ) \} \qquad [ Equation 57 ]$$

From now on, computation will be carried out in the same way as described in Section 2-1.

First, when the complex conjugate of the reference function V_{vrg} expressed in Equation 57 and the received signal V, expressed in Equation 17 are substituted into the matched filter expressed by Equation 11 as the reference function V* and the received signal Vᵣ, respectively, Equation 58 is obtained.

$${V}_{0}^{vrg} ( t ) = α exp ( - j \frac{4 π}{λ} {a}_{0} ) exp ( - j \frac{4 π}{λ} {a}_{1} ( t + Δ t ) ) \cdot {\int }_{- ∞}^{∞} a ( ξ - ( t + Δ t ) ) A ( ξ ) exp \{ j \frac{4 π}{λ} {a}_{2} ( t + Δ t ) ( 2 ξ - ( t + Δ t ) ) \} d ξ \qquad [ Equation 58 ]$$

An integral part D (expressed by Equation 59) in Equation 58 is computed in two cases where 0≧t+Δt and 0<t+Δt, for the same reason as with each of the integral parts A, B, and C.

$$( D ) = {\int }_{- ∞}^{∞} A ( ξ - ( t + Δ t ) ) A ( ξ ) exp \{ j \frac{4 π}{λ} {a}_{2} ( t + Δ t ) ( 2 ξ - ( t + Δ t ) ) \} d ξ \qquad [ Equation 59 ]$$

When 0≧t+Δt, Equation 59 is computed as shown in Equation 60.

$$( D ) = α ( τ - \vert t + Δ t \vert ) \cdot \frac{sin \{ \frac{4 π}{λ} {a}_{2} ( t + Δ t ) ( τ - \vert t + Δ t \vert ) \}}{\frac{4 π}{λ} {a}_{2} ( t + Δ t ) ( τ - \vert t + Δ t \vert )} \qquad [ Equation 60 ]$$

On the other hand, when 0<t+Δt, Equation 59 is computed as shown Equation 61.

$$( D ) = α ( τ - \vert t + Δ t \vert ) \cdot \frac{sin \{ \frac{4 π}{λ} {a}_{2} ( t + Δ t ) ( τ - \vert t + Δ t \vert ) \}}{\frac{4 π}{λ} {a}_{2} ( t + Δ t ) ( τ - \vert t + Δ t \vert )} \qquad [ Equation 61 ]$$

That is, in both of the cases where 0≧t+Δt and 0<t+Δt, the same result is obtained. Consequently, Equation 58 can be transformed to Equation 62.

$${V}_{0}^{vrg} ( t ) = α exp ( - j \frac{4 π}{λ} {a}_{0} ) exp ( - j \frac{4 π}{λ} {a}_{1} ( t + Δ t ) ) ( τ - \vert t + Δ t \vert ) \cdot \frac{sin \{ \frac{4 π}{λ} {a}_{2} ( t + Δ t ) ( τ - \vert t + Δ t \vert ) \}}{\frac{4 π}{λ} {a}_{2} ( t + Δ t ) ( τ - \vert t + Δ t \vert )} \qquad [ Equation 62 ]$$

“τ−|t+Δt|” can be physically interpreted in the similar manner to “τ−|t−t_{R}|” described in the explanation about the range compression. Consequently, by changing “t” to“t₀” in “τ−|t+Δt|”, Equation 62 can be transformed to Equation 63.

$${V}_{0}^{vrg} ( t ) = α exp ( - j \frac{4 π}{λ} {a}_{0} ) exp ( - j \frac{4 π}{λ} {a}_{1} ( t + Δ t ) ) ( τ - \vert {t}_{0} + Δ t \vert ) \cdot \frac{sin \{ \frac{4 π}{λ} {a}_{2} ( t + Δ t ) ( τ - \vert {t}_{0} + Δ t \vert ) \}}{\frac{4 π}{λ} {a}_{2} ( t + Δ t ) ( τ - \vert {t}_{0} + Δ t \vert )} \qquad [ Equation 63 ]$$

Further, when the absolute value is taken, Equation 63 can be converted to Equation 64.

$$\vert {V}_{0}^{vrg} ( t ) \vert = \vert α \vert ( τ - \vert {t}_{0} + Δ t \vert ) \cdot \vert \frac{sin \{ \frac{4 π}{λ} {a}_{2} ( t + Δ t ) ( τ - \vert {t}_{0} + Δ t \vert ) \}}{\frac{4 π}{λ} {a}_{2} ( t + Δ t ) ( τ - \vert {t}_{0} + Δ t \vert )} \vert \qquad [ Equation 64 ]$$

Then, when tₒ is set to 0, Equation 64 can be transformed to Equation 65.

$$\vert {V}_{0}^{vrg} ( t ) \vert = \vert α \vert ( τ - \vert Δ t \vert ) \cdot \vert \frac{sin \{ \frac{4 π}{λ} {a}_{2} ( t + Δ t ) ( τ - \vert Δ t \vert ) \}}{\frac{4 π}{λ} {a}_{2} ( t + Δ t ) ( τ - \vert Δ t \vert )} \vert \qquad [ Equation 65 ]$$

The position where the amplitude value becomes the maximum value in Equation 65 is determined by a portion (E) expressed by Equation 66. The position where the amplitude value becomes the maximum value is not important in this case. Thus, when the portion (E) is set to 1 to simplify Equation 65, Equation 67 is obtained.

$$\begin{matrix}( E ) = \vert \frac{sin \{ \frac{4 π}{λ} {a}_{2} ( t + Δ t ) ( τ - \vert Δ t \vert ) \}}{\frac{4 π}{λ} {a}_{2} ( t + Δ t ) ( τ - \vert Δ t \vert )} \vert & [ Equation 66 ] \\ \begin{matrix}\vert {V}_{0}^{vrg} ( t ) \vert = \vert α \vert ( τ - \vert Δ t \vert ) \\ = \vert α \vert ( τ - \vert \frac{{a}_{1} - {a}_{1}^{′}}{{a}_{2}} \vert )\end{matrix} & [ Equation 67 ]\end{matrix}$$

<3. Summary>

Equation 68 holds. Thus, Equation 20 is obtained from Equation 48 which is the result described in Section 2-2.

$$\begin{matrix}Δ = {a}_{2} - {a}_{2}^{′} \\ = \frac{1}{{R}_{0}} ( {v}_{a} - {v}_{a}^{′} ) ( {v}_{a} - {v}_{a}^{′} - 2 {v}_{P} )\end{matrix} \qquad [ Equation 68 ]$$

Further, Equation 69 holds. Thus, Equation 22 is obtained from

Equation 67 which is the result described in Section 2-3.

$${a}_{1} = {v}_{r} , {a}_{1}^{′} = {v}_{r}^{′} , {a}_{2} = \frac{{v}_{P}^{2}}{{R}_{0}} \qquad [ Equation 69 ]$$

A hardware configuration of the target velocity identification apparatus 1 in each of the embodiments will be described now.

FIG. 13 is a diagram showing an example of the hardware configuration of the target velocity identification apparatus 1. As shown in FIG. 13, the target velocity identification apparatus 1 includes a CPU 911 (Central Processing Unit, which is also referred to as a central processing device, a processing unit, an arithmetic operation unit, a microprocessor, a microcomputer, or a processor). The CPU 911 is connected to a ROM 913, a RAM 914, an LCD 901 (Liquid Crystal Display), a keyboard 902 (K/B), a communication board 915, and a magnetic disk device 920 through a bus 912, and controls these hardware devices. A storage device such as an optical disk device or a memory card read/write device may be employed in place of the magnetic disk device 920. The magnetic disk device 920 is connected through a predetermined fixed disk interface.

An operating system 921 (OS), a window system 922, programs 923, and files 924 are stored in the magnetic disk device 920 or the ROM 913. Each program of the programs 923 is executed by the CPU 911, the operating system 921, and the window system 922.

Software and programs for executing the functions described as the “data input unit 2”, the “step size determination unit 3”, the “predicted velocity input unit 4”, the “reference function production unit 5”, the “azimuth compression process unit 6”, the “amplitude value computation unit 7”, the “velocity identification unit 8”, and the like in the above description and the other programs are stored in the programs 923. The programs are read and executed by the CPU 911.

In the files 924, information and data described as the “range-compressed data”, the “step size”, the “predicted velocity “, the “reference function”, the “azimuth-compressed data”, and the “amplitude value”, signal values, variable values, and parameters are stored as respective items of a “database”. The “database” is stored in a storage medium such as a disk or a memory. The information, the data, the signal values, the variable values, and the parameters stored in the storage medium such as the disk or the memory are loaded into a main memory or a cache memory by the CPU 911 through a read/write circuit. Then, the information, the data, the signal values, the variable values, and the parameters that have been read are used for operations of the CPU such as extraction, retrieval, reference, comparison, arithmetic operation, computation, processing, output, printing, and display. During the operations of the CPU such as extraction, retrieval, reference, comparison, arithmetic operation, computation, processing, output, printing, and display, the information, the data, the signal values, the variable values, and the parameters are temporarily stored in the main memory, the cache memory, or a buffer memory.

An arrow portion in the flowcharts described in the above explanation mainly indicates a data or signal input/output. The data and the signal values are recorded in the memory of the RAM 914 and other recording media such as an optical disk and an IC chip. The data and signals are on-line transmitted through the bus 912, signal lines, cables, the other transmission media, or electric waves.

Each “- - - unit” in the above explanation may be a “- - - circuit”, an “- - - apparatus”, a “- - - device”, “- - - means”, or a “function”. Alternatively, each “- - - unit” may be a “- - - step”, a″- - - procedure“, or a “- - - process”. Further, each “- - - apparatus” described herein may be a “- - - circuit”, a “- - - device”, “means”, or a “function”. Alternatively, each “- - - apparatus” may be a “- - - step”, a “- - - procedure”, or a “- - - process”. Further, each “- - - process described herein may be a “- - - step”. That is, the “- - - unit” described herein may be implemented by firmware stored in the ROM 913. Alternatively, each “- - - unit” described herein may be implemented only by software, only by hardware such as elements, devices, a substrate, or wires, or by a combination of the software and the hardware, or further, by a combination of the software and the firmware. The firmware and the software are stored in a recording medium such as the ROM 913. Each program is read from the CPU 911 and is then executed by the CPU 911. That is, the program causes a computer or the like to function as the above-mentioned “- - - unit”. Alternatively, the program causes the above-mentioned procedure or method of the “- - - unit” to be executed by the computer or the like.

### REFERENCE SIGNS LIST

1: target velocity identification apparatus

2: data input unit

3: step size determination unit

4: predicted velocity input unit

5: reference function production unit

6: azimuth compression process unit

7: amplitude value computation unit

8: velocity identification unit

1. A target velocity identification apparatus which identifies a velocity of a target observed by a SAR (Synthetic Aperture Radar) comprising:
a data input unit which inputs data on the target observed by the SAR under observation conditions of a velocity v_{P} of a SAR platform with the SAR mounted thereon, a distance R₀ between the SAR and the target at a center of a synthetic aperture, a wavelength λ of an electric wave emitted from the SAR, and a synthetic aperture time τ;
a step size determination unit which inputs the velocity v_{P} of the SAR platform, the distance R₀, the wavelength λ, of the electric wave, and the synthetic aperture time τ being the observation conditions of the data input by the data input unit to a function of an amplitude value V₀^{vaz} expressed by the velocity v_{P} of the SAR platform, the distance R₀, the wavelength λ of the electric wave, the synthetic aperture time τ, and a predicted velocity vₐ′ of the target in an azimuth direction to compute the amplitude value V₀^{vaz} corresponding to the predicted velocity vₐ′, identifies a range of the predicted velocity vₐ′ in the azimuth direction where the amplitude value V₀^{vaz} becomes a predetermined value or larger by a processing device, and then sets a velocity width equal to or smaller than a velocity width of the identified range to a step size Δvₐ₁; and
an identification process execution unit which identifies the velocity of the target in the azimuth direction using the step size Δvₐ₁ determined by the step size determination unit.

2. The target velocity identification apparatus according to claim 1,
wherein the step size determination unit inputs the velocity v_{P} of the SAR platform, the distance R₀, the wavelength λ of the electric wave, and the synthetic aperture time τ being the observation conditions of the data input by the data input unit and also inputs a certain value as a velocity vₐ of the target, to the function of the amplitude value V₀^{vaz} expressed by Equation 1, thereby computing the amplitude value V₀^{vaz} corresponding to the predicted velocity vₐ′:
$$\vert {V}_{0}^{vaz} ( {v}_{a} , {v}_{a}^{′} ) \vert = - \vert α \vert \sqrt{\frac{λ {R}_{0}}{\vert ( {v}_{a} - {v}_{a}^{′} ) ( {v}_{a} + {v}_{a}^{′} - 2 {v}_{P} ) \vert}} \cdot \vert {\int }_{0}^{τ \sqrt{\vert ( {v}_{a} - {v}_{a}^{′} ) ( {v}_{a} + {v}_{a}^{′} - 2 {v}_{P} ) \vert / λ {R}_{0}}} exp ( ∓ j {p}^{2} ) d p \vert \qquad [ Equation 1 ]$$
where α is an arbitrary constant, j is an imaginary unit, and a lowercase p is an integral operator.

3. The target velocity identification apparatus according to claim 2,
wherein based on the function expressed by Equation 1, the step size determination unit sets a value larger than the amplitude value V₀^{vaz} at a top of a peak which is a second largest amplitude value in a graph to the predetermined value, the graph being obtained by plotting values of the amplitude value V₀^{vaz} for respective predicted velocities in the azimuth direction.

4. The target velocity identification apparatus according to claim 1,
wherein the data input unit inputs range-compressed data obtained by range compression, as the data on the target; and
wherein the identification process execution unit includes:
a predicted velocity input unit which inputs a predicted velocity of the target in a range direction, and also inputs the predicted velocities of the target in the azimuth direction for each step size Δvₐ₁ determined by the step size determination unit;
a reference function production unit which produces a reference function obtained from a relative distance between the SAR and the target, for each of the predicted velocities in the azimuth direction, using the processing device, based on the predicted velocity in the range direction and the predicted velocities in the azimuth direction input by the predicted velocity input unit, thereby producing a plurality of reference functions;
an azimuth compression process unit which azimuth compresses the range-compressed data input by the data input unit, based on each reference function of the plurality of reference functions produced by the reference function production unit, thereby generating a plurality of azimuth-compressed data, using the processing device;
an amplitude value computation unit which computes an amplitude value of an image of the target in each azimuth-compressed data of the plurality of azimuth-compressed data generated by the azimuth compression process unit, using the processing device; and
a velocity identification unit which, using the processing device, identifies that the velocity of the target in the azimuth direction falls within a range plus and minus a step size Δ vₐ₁/2 from one of the predicted velocities in the azimuth direction, the one of the predicted velocities in the azimuth direction being the predicted velocity used when the reference function production unit has produced the reference function used for generating the azimuth-compressed data having a maximum amplitude value of the image of the target computed by the amplitude value computation unit.

5. The target velocity identification apparatus according to claim 4,
wherein the predicted velocity input unit newly inputs the predicted velocities in the azimuth direction in the velocity range plus and minus the step size Δ vₐ₁/2 from the velocity identified by the velocity identification unit, for each step size Δvₐ₂ narrower than the step size Δvₐ₁;
wherein based on the predicted velocity in the range direction and the predicted velocities in the azimuth direction newly input by the predicted velocity input unit, the reference function production unit produces a reference function obtained from the relative distance, for each of the predicted velocities in the azimuth direction, thereby newly producing a plurality of reference functions;
wherein the azimuth compression process unit azimuth compresses the range-compressed data, based on each function of the plurality of reference functions newly produced by the reference function production unit, thereby newly generating a plurality of azimuth-compressed data;
wherein the amplitude value computation unit newly computes an amplitude value of an image of the target in each azimuth-compressed data of the plurality of azimuth-compressed data newly generated by the azimuth compression process unit; and
wherein the velocity identification unit identifies, as the velocity of the target in the azimuth direction, one of the predicted velocities in the azimuth direction, the one of the predicted velocities being the predicted velocity used when the reference function production unit has produced the reference function used for generating the azimuth-compressed data having a maximum amplitude value of the image of the target newly computed by the amplitude value computation unit.

6. The target velocity identification apparatus according to claim 5,
wherein the predicted velocity input unit newly inputs each of at least one velocity slower than a velocity vᵣ of the target in the range direction and at least one velocity faster than the velocity vᵣ of the target in the range direction, as the predicted velocity in the range direction;
wherein based on the predicted velocities in the range direction newly input by the predicted velocity input unit and the velocity of the target in the azimuth direction identified by the velocity identification unit, the reference function production unit produces a reference function obtained from the relative distance, for each of the predicted velocities in the range direction, thereby newly producing a plurality of reference functions;
wherein the azimuth compression process unit azimuth compresses the range-compressed data, based on each reference function of the plurality of reference functions newly produced by the reference function production unit, thereby newly generating a plurality of azimuth-compressed data;
wherein the amplitude value computation unit computes an amplitude value of an image of the target in each azimuth-compressed data of the plurality of azimuth-compressed data newly generated by the azimuth compression process unit; and
wherein the velocity identification unit identifies the velocity of the target in the range direction using a function of an amplitude value V₀^{vrg} expressed by the velocity v_{P} of the SAR platform, the distance R₀, the synthetic aperture time τ, and a predicted velocity vᵣ′ of the target in the range direction, based on the predicted velocities in the range direction input by the predicted velocity input unit and the amplitude value computed from each azimuth-compressed data by the amplitude value computation unit.

7. The target velocity identification apparatus according to claim 6,
wherein the velocity identification unit identifies the velocity of the target in the range direction by using the function of the amplitude value V₀^{vrg} expressed by Equation 2:
$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 2 ]$$
where α is the arbitrary constant.

8. The target velocity identification apparatus according to claim 6,
wherein the predicted velocity input unit inputs each of a velocity vᵣ₁′ slower than the velocity vᵣ of the target in the range direction and a velocity vᵣ₂′ faster than the velocity vᵣ of the target in the range direction, as the predicted velocity in the range direction; and
wherein the velocity identification unit substitutes into Equation 3 the predicted velocity vᵣ₁′ in the range direction and the predicted velocity vᵣ₂′ in the range direction input by the predicted velocity input unit, an amplitude value P₁ of the image of the target in the azimuth compressed data generated by the reference function produced based on the predicted velocity vᵣ₁′ in the range direction, and an amplitude value P₂ of the image of the target in the azimuth- compressed data generated by the reference function produced based on the predicted velocity vᵣ₂′ in the range direction, thereby identifying the velocity vᵣ of the target in the range direction:
$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 3 ]$$

9. The target velocity identification apparatus according to claim 6,
wherein the predicted velocity input unit inputs each of at least two velocities slower than the velocity vᵣ of the target in the range direction and at least two velocities faster than the velocity vᵣ of the target in the range direction, as the predicted velocity in the range direction; and
wherein the velocity identification unit computes a linear function of V₀^{vrg}=a₁vᵣ+a₂ (where a₁ and a₂ are constants) by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, computes a linear function of V₀^{vrg}=b₁vᵣ+b₂ (where b₁ and b₂ are constants) by the least square method, using the at least two predicted velocities in the range direction faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and identifies the velocity vᵣ in the range direction using the linear function of V₀^{vrg}=a₁vᵣ+a₂ and the linear function of V₀^{vrg}=b₁vᵣ+b₂.

10. The target velocity identification apparatus according to claim 5,
wherein the predicted velocity input unit newly inputs each of at least three predicted velocities in the range direction including at least one velocity slower than a velocity vᵣ of the target in the range direction and at least one velocity faster than the velocity vᵣ in the range direction, as the predicted velocity in the range direction;
wherein based on the predicted velocities in the range direction newly input by the predicted velocity input unit and the velocity of the target in the azimuth direction identified by the velocity identification unit, the reference function production unit produces a reference function obtained from the relative distance, for each of the predicted velocities in the range direction, thereby newly producing a plurality of reference functions;
wherein the azimuth compression process unit azimuth compresses the range-compressed data, based on each reference function of the plurality of reference functions newly produced by the reference function production unit, thereby newly generating a plurality of azimuth-compressed data;
wherein the amplitude value computation unit computes an amplitude value of an image of the target in each azimuth-compressed data of the plurality of azimuth-compressed data newly generated by the azimuth compression process unit; and
wherein the velocity identification unit computes a quadratic function of V₀^{vrg}=c₁vᵣ²+c₂v₁+c₃ (where c₁, c₂, and c₃ are constants) from the at least three predicted velocities in the range direction and the amplitude value computed from each azimuth-compressed data by the amplitude value computation unit, by a predetermined method, and identifies a velocity in the range direction at a base of the quadratic function as the velocity vᵣ of the target in the range direction.

11. A target velocity identification apparatus which identifies a velocity of a target observed by a SAR (Synthetic Aperture Radar) comprising:
a data input unit which inputs range-compressed data obtained by range compressing data on the target observed by the SAR based on a velocity v_{P} of a SAR platform with the SAR mounted thereon, a distance R₀ between the SAR and the target at a center of a synthetic aperture, and a synthetic aperture time τ;
a predicted velocity input unit which inputs each of at least one velocity slower than a velocity vᵣ of the target in a range direction and at least one velocity faster than the velocity vᵣ of the target in the range direction, as a predicted velocity in the range direction;
a reference function production unit which produces a reference function obtained from a relative distance between the SAR and the target expressed based on the velocity v_{P} of the SAR platform and the velocity of the target, for each of a plurality of predicted velocities in the range direction input by the predicted velocity input unit, using a processing device, based on the plurality of predicted velocities in the range direction and a velocity of the target in an azimuth direction, thereby producing a plurality of reference functions;
an azimuth compression process unit which azimuth compresses the range-compressed data input by the data input unit, based on each reference function of the plurality of reference functions produced by the reference function production unit, thereby generating a plurality of azimuth-compressed data, using the processing device;
an amplitude value computation unit which computes an amplitude value of an image of the target in each azimuth-compressed data of the plurality of azimuth-compressed data generated by the azimuth compression process unit; and
a velocity identification unit which identifies the velocity of the target in the range direction using a function of an amplitude value V₀^{vrg} expressed by the velocity v_{P} of the SAR platform, the distance R₀, the synthetic aperture time i, and a predicted velocity vᵣ′ of the target in the range direction, based on the plurality of predicted velocities in the range direction input by the predicted velocity input unit and the amplitude value computed from each azimuth-compressed data by the amplitude value computation unit.

12. The target velocity identification apparatus according to claim 11, wherein the velocity identification unit identifies the velocity of the target in the range direction by using the function of the amplitude value Vₒ^{vrg} expressed by Equation 4:
$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 4 ]$$
where α is an arbitrary constant.

13. The target velocity identification apparatus according to claim 11,
wherein the predicted velocity input unit inputs each of a velocity vᵣ₁′ slower than the velocity vᵣ of the target in the range direction and a velocity vᵣ₂′ faster than the velocity vᵣ of the target in the range direction, as the predicted velocity in the range direction; and
wherein the velocity identification unit substitutes into Equation 5 the predicted velocity vᵣ₁′ in the range direction and the predicted velocity vᵣ₂′ in the range direction input by the predicted velocity input unit, an amplitude value P₁ of the image of the target in the azimuth-compressed data generated by the reference function produced based on the predicted velocity Vᵣ₁′ in the range direction, and an amplitude value P₂ of the image of the target in the azimuth-compressed data generated by the reference function produced based on the predicted velocity vᵣ₂′ in the range direction, thereby identifying the velocity vᵣ of the target in the range direction:
$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 5 ]$$

14. The target velocity identification apparatus according to claim 11,
wherein the predicted velocity input unit inputs each of at least two velocities slower than the velocity vᵣ of the target in the range direction and at least two velocities faster than the velocity vᵣ of the target in the range direction, as the predicted velocity in the range direction; and
wherein the velocity identification unit computes a linear function of V₀^{vrg}=a₁vᵣa₂ (where a₁ and a₂ are constants) by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, computes a linear function of V₀^{vrg}=b₁vᵣ+b₂ (where b₁ and b₂ are constants) by the least square method, using the at least two predicted velocities in the range direction faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and identifies the velocity vᵣ in the range direction from the linear function of V₀^{vrg}=a₁vᵣ+a₂ and the linear function of V₀^{vrg}=b₁vᵣ+b₂.

15. A target velocity identification apparatus which identifies a velocity of a target observed by a SAR (Synthetic Aperture Radar) comprising:
a data input unit which inputs range-compressed data obtained by range compressing data on the target observed by the SAR;
a predicted velocity input unit which inputs at least three predicted velocities including at least one velocity slower than a velocity vᵣ of the target in a range direction and at least one velocity faster than the velocity vᵣ of the target in the range direction, as predicted velocities in the range direction;
a reference function production unit which produces a reference function obtained from a relative distance between the SAR and the target expressed based on a velocity v_{P} of a platform with the SAR mounted thereon and the velocity of the target, for each of the predicted velocities in the range direction input by the predicted velocity input unit, based on the predicted velocities and a velocity of the target in an azimuth direction, using a processing device, thereby producing a plurality of reference functions;
an azimuth compression process unit which azimuth compresses the range-compressed data input by the data input unit, based on each reference function of the plurality of reference functions produced by the reference function production unit, thereby generating a plurality of azimuth-compressed data, using the processing device;
an amplitude value computation unit which computes an amplitude value of an image of the target in each azimuth-compressed data of the plurality of azimuth-compressed data generated by the azimuth compression process unit; and
a velocity identification unit which computes a quadratic function of V₀^{vrg}=c₁vᵣ²c₂vᵣ+c₃ (where c₁, c₂, and c₃ are constants) from the at least three predicted velocities in the range direction input by the predicted velocity input unit and the amplitude value computed from each azimuth-compressed data by the amplitude value computation unit, by a predetermined method, and then identifies a velocity in the range direction at a base of the quadratic function as the velocity vᵣ of the target in the range direction, using the processing device.

16. A target velocity identification program which identifies a velocity of a target observed by a SAR (Synthetic Aperture Radar), for causing a computer to execute:
a data input process of inputting data on the target observed by the SAR under observation conditions of a velocity v_{P} of a SAR platform with the SAR mounted thereon, a distance R₀ between the SAR and the target at a center of a synthetic aperture, a wavelength λ of an electric wave emitted from the SAR, and a synthetic aperture time τ;
a step size determination process of inputting the velocity v_{P} of the SAR platform, the distance R₀, the wavelength λ of the electric wave, and the synthetic aperture time τ being the observation conditions of the data input in the data input process to a function of an amplitude value V₀^{vaz} expressed by the velocity v_{P} of the SAR platform, the distance R₀, the wavelength λ of the electric wave, the synthetic aperture time τ, and a predicted velocity vₐ′ of the target in an azimuth direction to compute the amplitude value V₀^{vaz} corresponding to the predicted velocity vₐ′, identifying a range of the predicted velocity vₐ′ in the azimuth direction where the amplitude value V₀^{vaz} becomes a predetermined value or larger, and then sets a velocity width equal to or smaller than a velocity width of the identified range to a step size Δvₐ₁; and
an identification process execution process of identifying the velocity of the target in the azimuth direction using the step size Δvₐ₁ determined in the step size determination process.

17. The target velocity identification program according to claim 16, wherein in the step-size determination process, the velocity v_{P} of the SAR platform, the distance R₀, the wavelength λ of the electric wave, and the synthetic aperture time τ being the observation conditions of the data input in the data input process and a certain value as a velocity vₐ of the target are input to the function of the amplitude value V₀^{vaz} expressed by Equation 6 , thereby computing the amplitude value V₀^{vaz} corresponding to the predicted velocity vₐ′:
$$\vert {V}_{0}^{vaz} ( {v}_{a} , {v}_{a}^{′} ) \vert = - \vert α \vert \sqrt{\frac{λ {R}_{0}}{\vert ( {v}_{a} - {v}_{a}^{′} ) ( {v}_{a} + {v}_{a}^{′} - 2 {v}_{P} ) \vert}} \cdot \vert {\int }_{0}^{τ \sqrt{\vert ( {v}_{a} - {v}_{a}^{′} ) ( {v}_{a} + {v}_{a}^{′} - 2 {v}_{P} ) \vert / λ {R}_{0}}} exp ( ∓ j {p}^{2} ) d p \vert \qquad [ Equation 6 ]$$
where α is an arbitrary constant, j is an imaginary unit, and a lowercase p is an integral operator.

18. The target velocity identification program according to claim 17, wherein in the step size determination process, based on the function expressed by Equation 6, a value larger than the amplitude value V₀^{vaz} at a top of a peak which is a second largest amplitude value in a graph is set to the predetermined value, the graph being obtained by plotting values of the amplitude value V₀^{vaz} for respective predicted velocities in the azimuth direction.

19. The target velocity identification program according to claim 16,
wherein in the data input process, range-compressed data obtained by range compression is input, as the data on the target; and
wherein in the identification process execution process, the computer is caused to execute:
a predicted velocity input process of inputting a predicted velocity of the target in a range direction, and also inputting the predicted velocities of the target in the azimuth direction for each step size Δvₐ₁ determined in the step size determination process;
a reference function production process of producing a reference function obtained from a relative distance between the SAR and the target, for each of the predicted velocities in the azimuth direction, based on the predicted velocity in the range direction and the predicted velocities in the azimuth direction input in the predicted velocity input process, thereby producing a plurality of reference functions;
an azimuth compression process of azimuth compressing the range-compressed data input in the data input process, based on each reference function of the plurality of reference functions produced in the reference function production process, thereby generating a plurality of azimuth-compressed data;
an amplitude value computation process of computing an amplitude value of an image of the target in each azimuth-compressed data of the plurality of azimuth-compressed data generated in the azimuth compression process; and
a velocity identification process of identifying that the velocity of the target in the azimuth direction falls within a range plus and minus a step size Δ vₐ₁/2 from one of the predicted velocities in the azimuth direction, the one of the predicted velocities in the azimuth direction being the predicted velocity used when the reference function used for generating the azimuth-compressed data having a maximum amplitude value of the image of the target computed in the amplitude value computation process has been produced in the reference function production process.

20. The target velocity identification program according to claim 19,
wherein in the predicted velocity input process, the predicted velocities in the azimuth direction in the velocity range plus and minus the step size Δ vₐ₁/2 from the velocity identified in the velocity identification process are newly input, for each step size Δvₐ₂ narrower than the step size Δv₀;
wherein in the reference function production process, a reference function obtained from the relative distance is produced for each of the predicted velocities in the azimuth direction newly input in the predicted velocity input process, based on the predicted velocity in the range direction and the predicted velocities in the azimuth direction, thereby newly producing a plurality of reference functions;
wherein in the azimuth compression process, the range-compressed data is azimuth compressed, based on each function of the plurality of reference functions newly produced in the reference function production process, thereby newly generating a plurality of azimuth-compressed data;
wherein in the amplitude value computation process, an amplitude value of an image of the target in each azimuth-compressed data of the plurality of azimuth-compressed data newly generated in the azimuth compression process is newly computed; and
wherein in the velocity identification process, one of the predicted velocities in the azimuth direction is identified as the velocity of the target in the azimuth direction, the one of the predicted velocities being the predicted velocity used when the reference function used for generating the azimuth-compressed data having a maximum amplitude value of the image of the target newly computed in the amplitude value computation process has been produced in the reference function production process.

21. The target velocity identification program according to claim 20,
wherein in the predicted velocity input process, each of at least one velocity slower than a velocity vᵣ of the target in the range direction and at least one velocity faster than the velocity vᵣ of the target in the range direction is newly input, as the predicted velocity in the range direction;
wherein in the reference function production process, based on the predicted velocities in the range direction newly input in the predicted velocity process and the velocity of the target in the azimuth direction identified in the velocity identification process, a reference function obtained from the relative distance is produced for each of the predicted velocities in the range direction, thereby newly producing a plurality of reference functions;
wherein in the azimuth compression process, the range-compressed data is azimuth compressed, based on each reference function of the plurality of reference functions newly produced in the reference function production process, thereby newly generating a plurality of azimuth-compressed data;
wherein in the amplitude value computation process, an amplitude value of an image of the target in each azimuth-compressed data of the plurality of azimuth-compressed data newly generated in the azimuth compression process is computed; and
wherein in the velocity identification process, the velocity of the target in the range direction is identified, using a function of an amplitude value V₀^{vrg} expressed by the velocity v_{P} of the SAR platform, the distance R₀, the synthetic aperture time τ, and a predicted velocity vᵣ′ of the target in the range direction, based on the predicted velocities in the range direction input in the predicted velocity input process and the amplitude value computed from each azimuth-compressed data in the amplitude value computation process.

22. The target velocity identification program according to claim 21, wherein in the velocity identification process, the velocity of the target in the range direction is identified by using the function of the amplitude value V₀^{vrg} expressed by Equation 7:
$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 7 ]$$
where α is the arbitrary constant.

23. The target velocity identification program according to claim 21,
wherein in the predicted velocity input process, each of a velocity vᵣ₁′ slower than the velocity vᵣ of the target in the range direction and a velocity vᵣ₂′ faster than the velocity vᵣ of the target in the range direction is input, as the predicted velocity in the range direction; and
wherein in the velocity identification process, the predicted velocity vᵣ₁′ in the range direction and the predicted velocity vᵣ₂′ in the range direction input in the predicted velocity input process, an amplitude value P₁ of the image of the target in the azimuth-compressed data generated by the reference function produced based on the velocity vᵣ₁′ in the range direction, and an amplitude value P₂ of the image of the target in the azimuth-compressed data generated by the reference function produced based on the velocity vᵣ₂′ in the range direction are substituted into Equation 8, thereby identifying the velocity vᵣ of the target in the range direction:
$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 8 ]$$

24. The target velocity identification program according to claim 21,
wherein in the predicted velocity input process, each of at least two velocities slower than the velocity vᵣ of the target in the range direction and at least two velocities faster than the velocity vᵣ of the target in the range direction is input, as the predicted velocity in the range direction;
wherein in the velocity identification process, a linear function of V₀^{vrg}=a₁vᵣ+a₂ (where a₁ and a₂ are constants) is computed by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, a linear function of V₀^{vrg}=b₁vᵣ+b₂ (where b₁ and b₂ are constants) is computed by the least square method, using the at least two predicted velocities in the range direction faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and the velocity vᵣ in the range direction is identified using the linear function of V₀^{vrg}=a₁vᵣ+a₂ and the linear function of V₀^{vrg}=b₁vᵣ+b₂.

25. The target velocity identification program according to claim 20,
wherein in the predicted velocity input process, each of at least three predicted velocities in the range direction including at least one velocity slower than a velocity vᵣ of the target in the range direction and at least one velocity faster than the velocity vᵣ of the target in the range direction is newly input, as the predicted velocity in the range direction;
wherein in the reference function production process, based on the predicted velocities newly input in the predicted velocity input process and the velocity of the target in the azimuth direction identified in the velocity identification process, a reference function obtained from the relative distance is produced for each of the predicted velocities in the range direction, thereby newly producing a plurality of reference functions;
wherein in the azimuth compression process, the range-compressed data is azimuth compressed, based on each reference function of the plurality of reference functions newly produced in the reference function production process, thereby newly generating a plurality of azimuth-compressed data;
wherein in the amplitude value computation process, an amplitude value of an image of the target in each azimuth-compressed data of the plurality of azimuth-compressed data newly generated in the azimuth compression process is computed; and
wherein in the velocity identification process, a quadratic function of V₀^{vrg}=c₁vᵣ²+c₂vᵣ+c₃ (where c₁, c₂, and c₃ are constants) is computed from the at least three predicted velocities in the range direction and the amplitude value computed from each azimuth-compressed data in the amplitude value computation process, by a predetermined method, and a velocity in the range direction at a base of the quadratic function is identified as the velocity vᵣ of the target in the range direction.

26. A target velocity identification program which identifies a velocity of a target observed by a SAR (Synthetic Aperture Radar) for causing a computer to execute:
a data input process of inputting range-compressed data obtained by range compressing data on the target observed by the SAR based on a velocity v_{P} of a SAR platform with the SAR mounted thereon, a distance R₀ between the SAR and the target at a center of a synthetic aperture, and a synthetic aperture time τ;
a predicted velocity input process of inputting each of at least one velocity slower than a velocity vᵣ of the target in a range direction and at least one velocity faster than the velocity vᵣ of the target in the range direction, as a predicted velocity in the range direction;
a reference function production process of producing a reference function obtained from a relative distance between the SAR and the target expressed based on the velocity v_{P} of the SAR platform and the velocity of the target, for each of a plurality of predicted velocities in the range direction input in the predicted velocity input process, based on the plurality of predicted velocities in the range direction and a velocity of the target in an azimuth direction, thereby producing a plurality of reference functions;
an azimuth compression process of azimuth compressing the range-compressed data input in the data input process, based on each reference function of the plurality of reference functions produced in the reference function production process, thereby generating a plurality of azimuth-compressed data;
an amplitude value computation process of computing an amplitude value of an image of the target in each azimuth-compressed data of the plurality of azimuth-compressed data generated in the azimuth compression process; and
a velocity identification process of identifying the velocity of the target in the range direction using a function of an amplitude value V₀^{vrg} expressed by the velocity Vₚ of the SAR platform, the distance R₀, the synthetic aperture time τ, and a predicted velocity vᵣ′ of the target in the range direction, based on the plurality of predicted velocities in the range direction input in the predicted velocity input process and the amplitude value computed from each azimuth-compressed data in the amplitude value computation process.

27. The target velocity identification program according to claim 26, wherein in the velocity identification process, the velocity of the target in the range direction is identified by using the function of the amplitude value V₀^{vrg} expressed by Equation 9:
$$\vert {V}_{0}^{vrg} ( {v}_{r} , {v}_{r}^{′} ) \vert = - \vert α \vert \frac{{R}_{0}}{{v}_{P}^{2}} \vert {v}_{r} - {v}_{r}^{′} \vert + \vert α \vert τ \qquad [ Equation 9 ]$$
where α is an arbitrary constant.

28. The target velocity identification program according to claim 26,
wherein in the predicted velocity input process, each of a velocity vᵣ₁′ slower than the velocity vᵣ of the target in the range direction and a velocity vᵣ₂′ faster than the velocity vᵣ of the target in the range direction is input, as the predicted velocity in the range direction; and
wherein in the velocity identification process, the predicted velocity vᵣ₁′ in the range direction and the predicted velocity v₁₂′ in the range direction input in the predicted velocity input process, an amplitude value P₁ of the image of the target in the azimuth-compressed data generated by the reference function produced based on the predicted velocity vᵣ₁′ in the range direction, and an amplitude value P₂ of the image of the target in the azimuth-compressed data generated by the reference function produced based on the predicted velocity vᵣ₂′ in the range direction are substituted into Equation 10, thereby identifying the velocity vᵣ of the target in the range direction:
$$\vert α \vert = \frac{{P}_{1} + {P}_{2}}{2 τ - \frac{{R}_{0}}{{v}_{P}^{2}} ( {v}_{r 2}^{′} - {v}_{r 1}^{′} )} \\ {v}_{r} = \frac{1}{2} \{ \frac{{v}_{P}^{2}}{α {R}_{0}} ( {P}_{2} - {P}_{1} ) + ( {v}_{r 1}^{′} + {v}_{r 2}^{′} ) \} \qquad [ Equation 10 ]$$

29. The target velocity identification program according to claim 26,
wherein in the predicted velocity input process, each of at least two velocities slower than the velocity vᵣ of the target in the range direction and at least two velocities faster than the velocity vᵣ of the target in the range direction is input, as the predicted velocity in the range direction; and
wherein in the velocity identification process, a linear function of V₀^{vrg}=a₁vᵣ+a₂ (where a₁ and a₂ are constants) is computed by a least square method, using the at least two predicted velocities in the range direction slower than the velocity vᵣ of the target in the range direction and the amplitude value of the image of the target in the azimuth-compressed data generated by the reference function produced based on each of the at least two predicted velocities in the range direction slower than the velocity vᵣ of the target in the range direction, a linear function of V₀^{vrg}=b₁vᵣ+b₂ (where b₁ and b₂ are constants) is computed by the least square method, using the at least two velocities faster than the velocity vᵣ of the target in the range direction and the amplitude value of the image of the target in the azimuth-compressed data generated by the reference function produced based on each of the at least two predicted velocities in the range direction faster than the velocity vᵣ of the target in the range direction, and the velocity vᵣ in the range direction is identified from the linear function of V₀^{vrg}=a₁vᵣ+a₂ and the linear function of V₀^{vrg}=b₁vᵣ+b₂.

30. A target velocity identification program which identifies a velocity of a target observed by a SAR (Synthetic Aperture Radar) for causing a computer to execute:
a data input process of inputting range-compressed data obtained by range compressing data on the target observed by the SAR;
a predicted velocity input process of inputting at least three predicted velocities including at least one velocity slower than a velocity vᵣ of the target in a range direction and at least one velocity faster than the velocity vᵣ of the target in the range direction, as predicted velocities in the range direction;
a reference function production process of producing a reference function obtained from a relative distance between the SAR and the target expressed based on a velocity v_{P} of a platform with the SAR mounted thereon and the velocity of the target, for each of the predicted velocities in the range direction input in the predicted velocity input process, based on the predicted velocities and a velocity of the target in an azimuth direction, thereby producing a plurality of reference functions;
an azimuth compression process of azimuth compressing the range-compressed data input in the data input process, based on each reference function of the plurality of reference functions produced in the reference function production process, thereby generating a plurality of azimuth-compressed data;
an amplitude value computation process of computing an amplitude value of an image of the target in each azimuth-compressed data of the plurality of azimuth-compressed data generated in the azimuth compression process; and
a velocity identification process of computing a quadratic function of V₀^{vrg}=c₁vᵣ²+c₂vᵣ+c₃ (where c₁, c₂, and c₃ are constants) from the at least three predicted velocities in the range direction input in the predicted velocity input process and the amplitude value computed from each azimuth-compressed data in the amplitude value computation process, by a predetermined method, and then identifying a velocity in the range direction at a base of the quadratic function as the velocity vᵣ of the target in the range direction.

31. A target velocity identification method of identifying a velocity of a target observed by a SAR (Synthetic Aperture Radar) comprising:
inputting data on the target observed by the SAR under observation conditions of a velocity v_{P} of a SAR platform with the SAR mounted thereon, a distance R₀ between the SAR and the target at a center of a synthetic aperture, a wavelength λ of an electric wave emitted from the SAR, and a synthetic aperture time τ;
inputting the velocity v_{P} of the SAR platform, the distance R₀, the wavelength λ of the electric wave, and the synthetic aperture time τ being the observation conditions of the data to a function of an amplitude value V₀^{vaz} expressed by the velocity v_{P} of the SAR platform, the distance R₀, the wavelength λ of the electric wave, the synthetic aperture time τ, and a predicted velocity vₐ′ of the target in an azimuth direction to compute the amplitude value V₀^{vaz} corresponding to the predicted velocity vₐ′, identifying a range of the predicted velocity vₐ′ in the azimuth direction where the amplitude value V₀^{vaz} becomes a predetermined value or larger, and then setting a velocity width equal to or smaller than a velocity width of the identified range to a step size Δvₐ₁; and
identifying the velocity of the target in the azimuth direction using the step size Δvₐ₁.
